(19) United States
(12) Patent Application Publication
(10) Pub. No.: US 2016/0023392 A1
(43) Pub. Date: Jan. 28, 2016

(54) METHODS AND APPARATUS FOR THE PRODUCTION OF MULTI-COMPONENT FIBERS

(71) Applicant: The University of Akron, Akron, OH (US)

(72) Inventors: Sadhan JANA, Fairlawn, OH (US); Rafael BENAVIDES, Akron, OH (US); Darrell RENEKER, Akron, OH (US)

(21) Appl. No.: 14/378,434

(22) PCT Filed: Feb. 12, 2013
(86) PCT No.: PCT/US13/25722

§ 371 Date: Aug. 13, 2014

Related U.S. Application Data
(60) Provisional application No. 61/597,928, filed on Feb. 13, 2012.
(60) Provisional application No. 61/597,933, filed on Feb. 13, 2012.
(60) Provisional application No. 61/703,796, filed on Sep. 21, 2012.

(51) Int. Cl. B29C 47/00; B29C 47/06; B29C 47/08

(52) U.S. Cl. CPC B29C 47/0014; B29C 47/084; B29C 47/06; B29C 47/0057

(57) ABSTRACT

The present invention is directed to apparatus and methods for making multi-component microfibers and nanofibers and non-woven fiber mats thereof. In some embodiments, the fibers have diameters ranging from 10 nm or more to 3000 nm or less. In some embodiments, the fibers are made of more than one component and have one or a mix of the following morphologies: core-sheath, side by side, stratified and/or interpenetrating structures. In some embodiments the multi-component fibers are made from two spinnable fluids and in other embodiments the multi-component fibers are made from a single spinnable solution having two different material dissolved within. Unlike certain prior art processes, the present invention does not involve application of an electrical charge to the spinnable fluid to produce the fibers and, as a result, the solvent selection is not limited to those solvents conducive to being electrically charged.

### CROSS REFERENCE TO RELATED APPLICATIONS

This application claims the benefit of U.S. provisional patent application Ser. No. 61/597,928 entitled “Process and Apparatus for the Production of Multi-component Fibers,” filed Feb. 13, 2012; U.S. provisional patent application Ser. No. 61/597,933 entitled “Nanofiber Jets Launched from Drops,” filed Feb. 13, 2012; and U.S. provisional patent application Ser. No. 61/703,796 entitled “Nanofiber Materials with Core and Shell, Interpenetrating and Side by Side Morphologies and Method of Making Them,” filed Sep. 21, 2012, all of which are incorporated by reference in their entirety.

### FIELD OF THE INVENTION

This invention is directed to apparatus and methods for producing multi-component microfibers and nanofibers and non-woven mats thereof with unique morphologies including but not limited to single, core and shell, side by side, and interpenetrating structures.

### BACKGROUND OF THE INVENTION

The production of fibers with sub-micron diameters or “nanofibers” has attracted significant attention in the last decades due to their high surface area per unit mass, unique surface roughness, and their great range of length, surface chemistry, and physical properties. These properties can be combined with the intrinsic properties of the polymers, such as biodegradability, crystallinity, and their hydrophobic or hydrophilic nature, to address an array of suitable applications often limited by the low rates of production of nanofibers. Examples of such suitable applications include, but are not limited to, scaffolds for cell growth, wound dressing materials for skin regeneration, industrial thermal and acoustic insulations systems, filtration, fabrication of protective clothing, sensors and catalytic matrices. The growth of the industry producing and selling sub-micron nanofibers relies heavily on the development of economical routes to produce them on an industrial scale.

Several methods have been proposed for economical commercial production of nanofibers. Electrospinning and melt blowing are among the most studied methods for making nanofibers, but other methods include solution blow spinning, centrifugal spinning, and rotary jet spinning. Literature reports regarding morphology control of nanofibers, particularly of multi-component nanofibers, are limited however, and recent efforts have focused on production of fibers with core-shell morphologies using syringe-in-syringe techniques on electrospinning processes.

Electrospinning uses electrical forces to create very fine fibers, with diameters typically in the order of a few nanometers to a few micrometers. However, the relatively low volume of fiber production from a single jet, typically less than 0.3 g/hour per jet, the high electric voltage necessary to draw the fibers, and the small number of polymer systems amenable to electrospinning, all limit more widespread industrial applications. In addition, the nature, type and length of multi-component fibers that can be made by electrospinning are limited because of differences in the electrical conductivity of the different spinnable fluids used. Moreover, the fact that nanofibers prepared by electrospinning often retain some of their electrical charge can limit their use in some applications.

Melt blowing processes use hot air currents to reduce the diameter, in complicated ways, of molten polymer extruded through a nozzle. Melt blowing has been used successfully to produce huge quantities of mats of fibers, of different materials, with diameters of several micrometers. However, melt blowing has generally been found unsuitable for making multi-component fibers having unique morphologies including but not limited to single, core and shell, side by side, and interpenetrating structures.

Another process with the potential to be economically viable for production of sub-micron fibers was developed at The University of Akron and is the subject of U.S. Pat. Nos. 6,382,526, 6,520,425, and 6,695,992, which are incorporated herein by reference in their entirety. This process, sometimes referred to as Nanofibers by Gas Jet (NGJ), uses hot gas jets flowing through annular nozzles where the gas and molten polymers or other fluid fiber forming materials are brought in contact and consequently lead to production of sub-micron fibers. However, because the annular nozzles through which the gas and fluid fiber making materials flow are coaxial, these nozzles are prone to clogging and have generally been found unsuitable for making multi-component fibers having unique morphologies including but not limited to single, core and shell, side by side, and interpenetrating structures.

Accordingly, there is a need in the art for efficient, flexible, and cost effective methods and related apparatus for the production of microfibers and nanofibers and non-woven single and/or multi-component fiber mats thereof. There is a need for such methods producing relatively small diameter single and multi-component nanofibers with a wide variety of useful morphologies including side by side, stratified, interpenetrating, and core-shell morphologies.

### SUMMARY OF THE INVENTION

The present invention is directed to an efficient, flexible, and cost effective method and related apparatus for the production of non-woven single and/or multi-component nanofiber mats that uses a relatively low velocity air stream to produce relatively small diameter single and multi-component nanofibers with a wide variety of useful morphologies including side by side, stratified, interpenetrating, and core-shell morphologies.

In a first aspect, the present invention is directed to an apparatus for forming a non-woven mat of fibers using a stream of pressurized gas comprising: a reservoir containing a spinnable fluid; a nozzle in fluid communication with the reservoir; a fluid pump for moving the spinnable fluid from the reservoir to the nozzle; a solid surface having an opening therethrough wherein the nozzle is oriented to deliver the spinnable fluid through the nozzle and onto the solid surface, wherein the solid surface is oriented so that the spinnable fluid flows downward along the solid surface when acted upon by the force of gravity; and a means for producing a stream of pressurized gas at a predetermined gas pressure and flow rate across some or all of the surface of the spinnable fluid on the solid surface to produce a fiber.

In one or more embodiments, the apparatus for forming a non-woven mat of fibers includes any one or more embodiments of the first aspect of the present invention further comprising: a first nozzle in fluid communication with a first fluid reservoir, the first fluid reservoir containing a first spinnable fluid; and a second nozzle in fluid communication with a second fluid reservoir, the second fluid reservoir containing a second spinnable fluid; wherein the first nozzle and the second nozzle are coaxial.

In one or more embodiments, the apparatus for forming a non-woven mat of fibers includes any one or more embodiments of the first aspect of the present invention further comprising: a first nozzle in fluid communication with a first fluid reservoir, the first fluid reservoir containing a first spinnable fluid; a second nozzle in fluid communication with a second fluid reservoir, the second fluid reservoir containing a second spinnable fluid; a solid surface having a first opening for receiving the first nozzle and a second opening for receiving the second nozzle; wherein the first nozzle and the second nozzle are oriented in a vertical arrangement.

In one or more embodiments, the apparatus for forming a non-woven mat of fibers includes any one or more embodiments of the first aspect of the present invention wherein the fluid pump is a syringe pump and at least one reservoir is housed within the syringe pump.

In one or more embodiments, the apparatus for forming a non-woven mat of fibers includes any one or more embodiments of the first aspect of the present invention wherein the means for producing a stream of pressurized gas at a predetermined gas pressure and flow rate comprises: an air compressor, a pressure regulator, a flow meter, and a rigid tube for directing the stream of pressurized gas.

In one or more embodiments, the apparatus for forming a non-woven mat of fibers includes any one or more embodiments of the first aspect of the present invention wherein the angle of the stream of pressurized gas relative to the solid surface is adjustable. In one or more embodiments, the apparatus for forming a non-woven mat of fibers includes any one or more embodiments of the first aspect of the present invention wherein the angle of the stream of pressurized gas relative to the solid surface is from about 0° to 180° and more preferably from about 30° to about 120.° In one or more embodiments, the apparatus for forming a non-woven mat of fibers includes any one or more embodiments of the first aspect of the present invention wherein the angle of the stream of pressurized gas relative to horizontal is from about 0° to 180° and more preferably from about 30° to about 120.°

In one or more embodiments, the apparatus for forming a non-woven mat of fibers includes any one or more embodiments of the first aspect of the present invention wherein the flow rate is from about 0.05 cubic meters per second to about 0.5 cubic meters per second and more preferably from about 0.1 cubic meters per second to about 0.2 cubic meters per second. In one or more embodiments, the apparatus for forming a non-woven mat of fibers includes any one or more embodiments of the first aspect of the present invention wherein the gas pressure is from about 5 psi to about 100 psi, and more preferably from about 10 psi to about 40 psi. In one or more embodiments, the apparatus for forming a non-woven mat of fibers includes any one or more embodiments of the first aspect of the present invention wherein the feeding rate of the spinnable fluid, first spinnable fluid or second spinnable fluid through the nozzle is from about 0.1 mL per minute to about 10.0 mL per minute and more preferably from about 0.3 mL per minute to about 2.0 mL per minute.

In one or more embodiments, the apparatus for forming a non-woven mat of fibers includes any one or more embodiments of the first aspect of the present invention further comprising a plurality nozzles for production of a plurality of fibers. In one or more embodiments, the apparatus for forming a non-woven mat of fibers includes any one or more embodiments of the first aspect of the present invention wherein the plurality of nozzles are arranged in an array.

In one or more embodiments, the apparatus for forming a non-woven mat of fibers includes any one or more embodiments of the first aspect of the present invention further comprising a fiber collection area. In one or more embodiments, the apparatus for forming a non-woven mat of fibers includes any one or more embodiments of the first aspect of the present invention wherein the fiber collection area is located from about 2 centimeters to about 500 centimeters from the solid surface and more preferably from about 10 centimeters to about 180 centimeters from the solid surface.

In one or more embodiments, the apparatus for forming a non-woven mat of fibers includes any one or more embodiments of the first aspect of the present invention further comprising: a first nozzle in fluid communication with a first fluid reservoir the first fluid reservoir being housed within a first syringe pump, wherein the first fluid reservoir contains a first spinnable fluid, the feeding rate of the first spinnable fluid through the first nozzle is from about 0.3 mL per minute to about 2.0 mL per minute, and the first spinnable fluid is a solution selected from the group consisting of polyethylene oxide dissolved in ethanol, polyvinyl pyrrolidone dissolved in ethanol, and polyvinyl acetate dissolved in ethyl acetate; and a second nozzle in fluid communication with a second fluid reservoir, the second fluid reservoir being housed within a second syringe pump, wherein the second fluid reservoir containing a second spinnable fluid, the feeding rate of the second spinnable fluid through the second nozzle is from about 0.3 mL per minute to about 2.0 mL per minute, and the second spinnable fluid is a solution selected from the group consisting of polyethylene oxide dissolved in ethanol, polyvinyl pyrrolidone dissolved in ethanol, and polyvinyl acetate dissolved in ethyl acetate; wherein the stream of pressurized gas comprises compressed air and the means for producing the stream of pressurized gas at a predetermined gas pressure and flow rate comprises a source of compressed air, a pressure regulator, a flow meter, and a rigid tube for directing the stream of pressurized gas; the angle of the stream of pressurized gas relative to the solid surface is adjustable with the angle of the stream of pressurized gas relative to the solid surface being from about 30° to about 120° and the angle of the stream of pressurized gas relative to horizontal being from about 30° to about 120°-; the flow rate is from about 0.10 cubic meters per second to about 0.20 cubic meters per second and the gas pressure is from about 10 psi to about 40 psi; and the fiber collection area is located from about 2 centimeters to about 200 centimeters from the solid surface.

In one or more embodiments, the apparatus for forming a non-woven mat of fibers includes any one or more embodiments of the first aspect of the present invention wherein the fiber formed by the apparatus is a nanofiber.

A second aspect of the present invention is directed to an apparatus for forming a non-woven mat of fibers comprising: a capillary tube nozzle having a source end and an exit end, a spinnable fluid, the spinnable fluid entering the capillary tube nozzle at the source end, traveling the length of the capillary tube nozzle, and forming a pendent drop at the exit end of the capillary tube nozzle; and a means for producing a stream of pressurized gas at a predetermined flow rate and pressure across the pendent drop of the spinnable fluid to produce fibers.

In one or more embodiments, the apparatus for forming a non-woven mat of fibers includes any one or more embodiments of the second aspect of the present invention wherein the means for producing a stream of pressurized gas at a predetermined gas pressure and flow rate comprises: an air compressor, a pressure regulator, a flow meter, and a rigid tube for directing the stream of pressurized gas.

In one or more embodiments, the apparatus for forming a non-woven mat of fibers includes any one or more embodiments of the second aspect of the present invention wherein the flow rate is from about 0.05 cubic meters per second to about 0.5 cubic meters per second and more preferably is from about 0.1 cubic meters per second to about 0.2 cubic meters per second. In one or more embodiments, the apparatus for forming a non-woven mat of fibers includes any one or more embodiments of the second aspect of the present invention wherein the gas pressure is from about 10 psi to about 40 psi.

In one or more embodiments, the apparatus for forming a non-woven mat of fibers includes any one or more embodiments of the second aspect of the present invention further comprising a fiber collection area. In one or more embodiments, the apparatus for forming a non-woven mat of fibers includes any one or more embodiments of the second aspect of the present invention wherein the fiber collection area is located from about 2 centimeters to about 500 centimeters and more preferably is from about 10 centimeters to about 180 centimeters from the capillary tube.

In one or more embodiments, the apparatus for forming a non-woven mat of fibers includes any one or more embodiments of the second aspect of the present invention wherein the exit end of the capillary tube nozzle has an internal diameter of from about 0.5 millimeters to about 4.0 millimeters and more preferably is from about 1.0 millimeters to about 2.0 millimeters. In one or more embodiments, the apparatus for forming a non-woven mat of fibers includes any one or more embodiments of the second aspect of the present invention wherein the exit end of the capillary tube nozzle has an internal diameter of 1 millimeter.

In one or more embodiments, the apparatus for forming a non-woven mat of fibers includes any one or more embodiments of the second aspect of the present invention further comprising a plurality capillary tube nozzles for production of a plurality of fibers. In one or more embodiments, the apparatus for forming a non-woven mat of fibers includes any one or more embodiments of the second aspect of the present invention wherein the plurality of capillary tube nozzles are arranged in an array.

In one or more embodiments, the apparatus for forming a non-woven mat of fibers includes any one or more embodiments of the second aspect of the present invention wherein the fiber formed by the apparatus is a nanofiber.

In a third aspect, the present invention is directed to an apparatus for forming a non-woven mat of fibers comprising: a needle tip nozzle having a source end and an exit end, a spinnable fluid, the spinnable fluid entering the needle tip nozzle at the source end, traveling the length of the needle tip nozzle, and exiting from the exit end of the needle tip nozzle; and a means for producing a stream of pressurized gas at a predetermined flow rate and pressure across the spinnable fluid as it leaves the exit end of the needle tip nozzle to produce fibers.

In one or more embodiments, the apparatus for forming a non-woven mat of fibers includes any one or more embodiments of the third aspect of the present invention wherein the means for producing a stream of pressurized gas at a predetermined gas pressure and flow rate comprises: an air compressor, a pressure regulator, a flow meter, and a rigid tube for directing the stream of pressurized gas.

In one or more embodiments, the apparatus for forming a non-woven mat of fibers includes any one or more embodiments of the third aspect of the present invention wherein the flow rate is from about 0.05 cubic meters per second to about 0.5 cubic meters per second and more preferably is from about 0.1 cubic meters per second to about 0.2 cubic meters per second. In one or more embodiments, the apparatus for forming a non-woven mat of fibers includes any one or more embodiments of the third aspect of the present invention wherein the gas pressure is from about 5 psi to about 100 psi and more preferably is from about 10 psi to about 40 psi.

In one or more embodiments, the apparatus for forming a non-woven mat of fibers includes any one or more embodiments of the third aspect of the present invention further comprising a fiber collection area.

In one or more embodiments, the apparatus for forming a non-woven mat of fibers includes any one or more embodiments of the third aspect of the present invention wherein the fiber collection area is located from about 2 centimeters to about 500 centimeters and more preferably is from about 10 centimeters to about 180 centimeters from the capillary tube. In one or more embodiments, the apparatus for forming a non-woven mat of fibers includes any one or more embodiments of the third aspect of the present invention wherein the exit end of the needle tip nozzle has an internal diameter of from about 0.1 millimeters to about 3.0 millimeters and more preferably is from about 0.3 millimeters to about 1.22 millimeters.

In one or more embodiments, the apparatus for forming a non-woven mat of fibers includes any one or more embodiments of the third aspect of the present invention further comprising a plurality of needle-tip nozzles for production of a plurality of fibers. In one or more embodiments, the apparatus for forming a non-woven mat of fibers includes any one or more embodiments of the third aspect of the present invention wherein the plurality of needle-tip nozzles are arranged in an array.

In one or more embodiments, the apparatus for forming a non-woven mat of fibers includes any one or more embodiments of the third aspect of the present invention wherein the fiber formed by the apparatus is a nanofiber.

In a forth aspect, the present invention is directed to a spinnable fluid for making multi-component fibers having a predetermined morphology comprising: a plurality of spinnable materials for forming fibers, each of the plurality of spinnable materials being soluble in at least one solvent, wherein all of the solvents are miscible with each other at the temperature range to be used in the production of the fibers and at least one of the solvents is a good solvent for at least one of the spinnable materials; and the spinnable fluid is stable against any one of coagulation, precipitation, stratification, and phase separation until use.

In one or more embodiments, the spinnable fluid for making multi-component fibers includes any one or more embodiments of the fourth aspect of the present invention wherein the plurality of spinnable materials for forming fibers comprises a first spinnable material soluble in a first solvent and a second spinnable material soluble in a different second solvent. In one or more embodiments, the spinnable fluid for making multi-component fibers includes any one or more embodiments of the fourth aspect of the present invention wherein the first spinnable material is hydrophobic and the second spinnable material is hydrophilic.

In one or more embodiments, the spinnable fluid for making multi-component fibers includes any one or more embodiments of the fourth aspect of the present invention wherein the plurality of spinnable materials, first spinnable material or second spinnable material comprises one or more spinnable material selected from the group consisting of polyethylene oxide, polyvinyl pyrrolidone, polyvinyl acetate, nylon, polyurethane, polybenzimidazole, polycarbonate, polyacrylonitrile, polyvinyl alcohol, polylactic acid, polyethylene-co-vinyl acetate, polymethyl metacrylate, polyaniline, collagen, gelatin, silk-like polymer, polyvinylcarbazole, polyethylene terephtalate, polyacrilic acid, polystyrene, polyiamide, polyninylchlororide, cellulose acetate, polyacrilamide, polycaprolactone, polyvinylidene fluoride, polyether imide, polyethylene, polypropylene, polyethylene naphtalate, mesophase pitch, polyacrylonitrile, coal tar, zirconium (IV) propoxide, titanium (IV) isopropoxide, yttrium nitrate hexahydrate, tetraethyl orthosilicate, zinc acetate, and copper nitrate.

In one or more embodiments, the spinnable fluid for making multi-component fibers includes any one or more embodiments of the fourth aspect of the present invention wherein the at least one solvent, first solvent, or second solvent comprises one or more solvents selected from the group consisting of water, methanol, ethanol, isopropanol, n-butanol, acetone, chloroform, formic acid, dimethyl formamide, chloroform, dichloromethane, tetrahydrofuran, methylene chloride, methylethylketone, carbon disulfide, toluene, xylene, benzene, acetic acid, hexafluoro-2-propanol, and hexafluoroisopropanol.

In one or more embodiments, the spinnable fluid for making multi-component fibers includes any one or more embodiments of the fourth aspect of the present invention wherein the first spinnable material is polyvinyl pyrrolidone and the second spinnable material is polyvinyl acetate. In one or more embodiments, the spinnable fluid for making multi-component fibers includes any one or more embodiments of the fourth aspect of the present invention wherein the first spinnable material is polyvinyl pyrrolidine and the first solvent is methanol. In one or more embodiments, the spinnable fluid for making multi-component fibers includes any one or more embodiments of the fourth aspect of the present invention wherein the second spinnable material is polyvinyl acetate and the second solvent is ethyl acetate. In one or more embodiments, the spinnable fluid for making multi-component fibers includes any one or more embodiments of the fourth aspect of the present invention wherein the first solvent is isopropanol and the second solvent is ethyl acetate. In one or more embodiments, the spinnable fluid for making multi-component fibers includes any one or more embodiments of the fourth aspect of the present invention wherein the first solvent is 1-butanol and the second solvent is ethyl acetate.

In one or more embodiments, the spinnable fluid for making multi-component fibers includes any one or more embodiments of the fourth aspect of the present invention wherein the proportion of the plurality of components for forming fibers in the spinnable fluid is from about 10 percent to about 90 percent by weight and more preferably is from about 20 percent to about 80 percent by weight. In one or more embodiments, the spinnable fluid for making multi-component fibers includes any one or more embodiments of the fourth aspect of the present invention wherein the proportion of the plurality of components for forming fibers in the spinnable fluid is from about 1 percent by weight to about 30 percent by weight and more preferably is from about 3 percent by weight to about 15 percent by weight. In one or more embodiments, the spinnable fluid for making multi-component fibers includes any one or more embodiments of the fourth aspect of the present invention wherein the ratio of the weight of the first spinnable material to the weight of the second spinnable material in the spinnable fluid is from about 1 to 1 to about 2 to 1. In one or more embodiments, the spinnable fluid for making multi-component fibers includes any one or more embodiments of the fourth aspect of the present invention wherein the ratio of the weight of the first solvent to the weight of the second solvent in the spinnable fluid is about 1 to 1.

In one or more embodiments, the spinnable fluid for making multi-component fibers includes any one or more embodiments of the fourth aspect of the present invention wherein the ratio of the vapor pressure of the first solvent at 20 degrees Centigrade to the vapor pressure of water at 20 degrees Centigrade is from about 0.01 to about 50.00 weight and more preferably is from about 0.01 to about 20.00. In one or more embodiments, the spinnable fluid for making multi-component fibers includes any one or more embodiments of the fourth aspect of the present invention wherein the ratio of the vapor pressure of the second solvent at 20 degrees Centigrade to the vapor pressure of water at 20 degrees Centigrade is from about 0.01 to about 50.00 weight and more preferably is from about 0.01 to about 20.00.

In one or more embodiments, the spinnable fluid for making multi-component fibers includes any one or more embodiments of the fourth aspect of the present invention wherein the first spinnable material has an affinity for the first solvent of from about 0.001 MPa to about 10 MPa, and is preferably between about 0.001 MPa to about 5 MPa and an affinity for the second solvent of from about 10 MPa to about 45 MPa. In one or more embodiments, the spinnable fluid for making multi-component fibers includes any one or more embodiments of the fourth aspect of the present invention wherein the second spinnable material has an affinity for the second solvent of from about 0.001 MPa and about 5 MPa and an affinity for the first solvent of from about 10 MPa to about 45 MPa.

In one or more embodiments, the spinnable fluid for making multi-component fibers includes any one or more embodiments of the fourth aspect of the present invention wherein the predetermined morphology is an interpenetrating morphology and the ratio of the solvent evaporation rate for the first solvent to the solvent evaporation rate of the second solvent is from about 0.8:1 to about 1:1 weight and more preferably is from about 0.9:1 to about 1:1.

In one or more embodiments, the spinnable fluid for making multi-component fibers includes any one or more embodiments of the fourth aspect of the present invention wherein the predetermined morphology is a side by side morphology and the ratio of the solvent evaporation rate for the first solvent to the solvent evaporation rate of the second solvent is from about 5:1 to about 2.5:1 weight and more preferably is from about 3:1 to about 2.5:1. In one or more embodiments, the spinnable fluid for making multi-component fibers includes any one or more embodiments of the fourth aspect of the present invention wherein the predetermined morphology is a core and sheath morphology and the ratio of the solvent evaporation rate for the first solvent to the solvent evaporation rate of the second solvent is from about 20:1 to about 10:1 weight and more preferably is from about 15:1 to about 10:1.

In one or more embodiments, the spinnable fluid for making multi-component fibers includes any one or more embodiments of the fourth aspect of the present invention further comprising at least one additive that will become sequestered in the fibers. In one or more embodiments, the spinnable fluid for making multi-component fibers includes any one or more embodiments of the fourth aspect of the present invention wherein the at least one additive is an additive selected from the group consisting of nanoparticles, colloids, small crystals, fluid droplets, trisilanol isobutyl polyhedral oligomeric silsesquinoxane (POSS) particles, soluble sol-gel precursors in that form into insoluble nanoparticles, inorganic pigments, small molecules capable of exhibiting therapeutic benefits, small molecules capable of exhibiting optical and electronic properties or stimuli responsive behavior, catalysts, catalytic precursors, cells, organelles, and biomolecules.

In one or more embodiments, the spinnable fluid for making multi-component fibers includes any one or more embodiments of the fourth aspect of the present invention wherein the fibers produced are nanofibers.

In one or more embodiments, the present invention includes any one or more embodiments of the first, second, or third aspects of the present invention wherein the spinnable fluid is the spinnable fluid of any one or more embodiment of the fourth aspect of the present invention.

In a fifth aspect, the present invention is directed to a method of making multi-component fibers having a predetermined morphology comprising the steps of: preparing a spinnable fluid, wherein the spinnable fluid comprises a spinnable material and at least one solvent for the spinnable material; feeding the spinnable fluid at a predetermined feeding rate through a nozzle and onto a solid surface; wherein the solid surface is oriented so that the at least one spinnable fluid flows downward along the solid surface when acted upon by the force of gravity; providing a stream of pressurized gas, wherein the stream of pressurized gas has a gas pressure of from about 5 psi and about 100 psi and a flow rate of from about 0.05 cubic meters per second to about 0.5 cubic meters per second; directing the stream of pressurized gas across the surface of the spinnable fluid as it flows down the solid surface; wherein the stream of pressurized gas contacts on the surface of the spinnable fluid, stretching it out to form fibers of the spinnable material as the at least one solvent evaporates.

In one or more embodiments, the method of making multi-component fibers having a predetermined morphology includes any one or more embodiments of the fifth aspect of the present invention wherein the method further comprises: a first spinnable fluid comprising a first spinnable material and at least one solvent for the spinnable material; and a second spinnable fluid comprising a second spinnable material and at least one solvent for the second spinnable material.

In one or more embodiments, the method of making multi-component fibers having a predetermined morphology includes any one or more embodiments of the fifth aspect of the present invention further comprising the steps of: substantially simultaneously feeding the first spinnable fluid through a first nozzle and onto the solid surface and the second spinnable fluid through a second nozzle and onto the solid surface. directing the stream of pressurized gas across the surface of the first spinnable fluid and the second spinnable fluid wherein the stream of pressurized gas contacts on the surface of the first spinnable fluid and the second spinnable fluid, stretching them out to form fibers of both the first spinnable material and the second spinnable material as the at least one solvent for the first spinnable material and the at least one solvent for the second spinnable material evaporate.

In one or more embodiments, the method of making multi-component fibers having a predetermined morphology includes any one or more embodiments of the fifth aspect of the present invention wherein the first nozzle and the second are coaxial. In one or more embodiments, the method of making multi-component fibers having a predetermined morphology includes any one or more embodiments of the fifth aspect of the present invention wherein: the solid surface includes a first opening for receiving the first nozzle and a second opening for receiving the second nozzle; and wherein the first nozzle and the second nozzle are oriented in a vertical arrangement.

In one or more embodiments, the method of making multi-component fibers having a predetermined morphology includes any one or more embodiments of the fifth aspect of the present invention further comprising the steps of: feeding the first spinnable fluid at a predetermined feeding rate through the first nozzle and onto a solid surface; feeding the second spinnable fluid at a predetermined feeding rate through the second nozzle and onto a solid surface; directing the stream of pressurized gas across the surface of the first spinnable fluid and the second spinnable as they flow down the solid surface; wherein the stream of pressurized gas contacts the surface of the first spinnable fluid and the second spinnable fluid, stretching them out to form fibers of both the first spinnable material and the second spinnable material as the at least one solvent for the first spinnable material and the at least one solvent for the second spinnable material evaporate.

In one or more embodiments, the method of making multi-component fibers having a predetermined morphology includes any one or more embodiments of the fifth aspect of the present invention further comprising the steps of: providing a fiber collection area to receive the fibers wherein the fiber collection area is located from about 2 centimeters to about 500 centimeters, and preferably from about 10 centimeters to about 200 centimeters from the solid surface; and collecting the fibers.

In one or more embodiments, the method of making multi-component fibers having a predetermined morphology includes any one or more embodiments of the fifth aspect of the present invention wherein the fibers have an interpenetrating morphology.

In one or more embodiments, the method of making multi-component fibers having a predetermined morphology includes any one or more embodiments of the fifth aspect of the present invention wherein the fibers have a side by side morphology.

In one or more embodiments, the method of making multi-component fibers having a predetermined morphology includes any one or more embodiments of the fifth aspect of the present invention wherein the fibers have a core and sheath morphology.

In a sixth aspect, the present invention is directed to a method of making multi-component fibers having a predetermined morphology comprising the steps of: preparing a spinnable fluid, wherein the spinnable fluid comprises a spinnable material and at least one solvent for the at least one spinnable material; feeding the spinnable fluid at a predetermined feeding rate through at a capillary tube; forming a pendant drop of the spinnable fluid on the end of the capillary tube; providing a stream of pressurized gas, wherein the stream of pressurized gas has a gas pressure of from about 5 psi and about 100 psi, and a flow rate of from about 0.05 cubic meters per second to about 0.5 cubic meters per second; and directing the stream of pressurized gas across the surface of the pendent drop of the spinnable fluid at a predetermined angle; wherein the stream of pressurized gas is expanding and acts on the surface of the pendant drop, stretching it out to form fibers of the spinnable material as the at least one solvent evaporates. The term “pendant drop” as used herein, means a drop of fluid suspended from the end of a tube and held in place by surface tension forces.

In a seventh aspect, the present invention is directed to a method of making multi-component fibers having a predetermined morphology comprising the steps of: preparing a spinnable fluid, wherein the spinnable fluid comprises a spinnable material and at least one solvent for the at least one spinnable material; feeding the spinnable fluid at a predetermined feeding rate through at a needle-tip nozzle; providing a stream of pressurized gas, wherein the stream of pressurized gas has a gas pressure of from about 5 psi and about 100 psi, and a flow rate of from about 0.05 cubic meters per second to about 0.5 cubic meters per second; and directing the stream of pressurized gas across the surface of the spinnable fluid as it exits the needle-tip nozzle, wherein the stream of pressurized gas creates a fluid jet of the spinnable fluid which then solidifies to form fibers of the spinnable material as the at least one solvent evaporates.

In one or more embodiments, the method of making multi-component fibers having a predetermined morphology includes any one or more embodiments of the seventh aspect of the present invention wherein further comprising the steps of: providing a fiber collection area to receive the fibers wherein the fiber collection area is located from about 2 centimeters to about 500 centimeters, and preferably from about 10 centimeters to about 200 centimeters from the solid surface; and collecting the fibers.

In one or more embodiments, the present invention includes any one or more embodiments of the fifth, sixth, or seventh aspects of the present invention wherein the spinnable fluid is the spinnable fluid of any one or more embodiment of the fourth aspect of the present invention.

In one or more embodiments, the present invention includes any one or more embodiments of the fifth, sixth, or seventh aspects of the present invention wherein the fibers have an interpenetrating morphology. In one or more embodiments, the present invention includes any one or more embodiments of the fifth, sixth, or seventh aspects of the present invention wherein the fibers have a side by side morphology. In one or more embodiments, the present invention includes any one or more embodiments of the fifth, sixth, or seventh aspects of the present invention wherein the fibers have a core and sheath morphology. In one or more embodiments, the present invention includes any one or more embodiments of the fifth, sixth, or seventh aspects of the present invention wherein the fibers are nanofibers.

### BRIEF DESCRIPTION OF THE DRAWINGS

FIG. 1 is a schematic representation of the overall apparatus to produce fibers according to at least one embodiment of the present invention.

FIG. 2 is a side view of wall-anchored nozzle and solid surface section of an embodiment of an apparatus to produce fibers according to at least one embodiment of the present invention.

FIG. 3 is a schematic diagram of a wall-anchored nozzle embodiment of an apparatus to produce fibers according to at least one embodiment of the present invention.

FIG. 4 is a schematic diagram of a co-axial wall-anchored nozzle embodiment of an apparatus to produce fibers according to at least one embodiment of the present invention.

FIG. 5A is a cross-sectional view of a co-axial wall-anchored nozzle arrangement according to at least one embodiment of the present invention.

FIG. 5B is an end view of a co-axial wall-anchored nozzle arrangement according to at least one embodiment of the present invention.

FIG. 6 is a schematic diagram of a dual wall-anchored nozzle embodiment of an apparatus to produce fibers according to at least one embodiment of the present invention.

FIG. 7A is a schematic representation of bi-component fibers with interpenetrating morphology.

FIG. 7B is a schematic representation of bi-component fibers with side by side morphology.

FIG. 7C is a schematic representation of bi-component fibers with core and sheath morphology.

FIG. 8 is an SEM image of nanofibers with side-by-side morphologies produced using a wall-anchored nozzle according to at least one embodiment of the present invention.

FIG. 9 is a schematic representation of the apparatus to produce fibers according to this invention using a capillary tube nozzle.

FIG. 10 is a schematic representation of the apparatus to produce fibers according to this invention using a needle tip nozzle.

FIG. 11 is a high speed photograph of a fluid jet generated using a wall-anchored nozzle embodiment of an apparatus to produce fibers according to at least one embodiment of the present invention.

FIG. 12 is an SEM image taken nanofibers containing trisilanol isobutyl POSS particles formed using a wall-anchored nozzle embodiment of an apparatus to produce fibers according to at least one embodiment of the present invention.

FIG. 13A-C shows three SEM images reflecting different conglutination levels of polyethylene oxide (“PEO”) nanofibers made according to at least one embodiment of the present invention and collected at distances from the nozzle of 10 cm (A), 50 cm (B), and 100 cm (C).

FIG. 14 is a SEM image of nanofibers formed using a co-axial wall-anchored nozzle embodiment of an apparatus to produce fibers according to at least one embodiment of the present invention and having core-sheath morphology.

FIG. 15 is a TEM image of nanofibers formed using a co-axial wall-anchored nozzle embodiment of an apparatus to produce fibers according to at least one embodiment of the present invention and having core-sheath morphology.

FIG. 16 is a high speed photograph of a fluid jet generated using a pendent drop nozzle embodiment of an apparatus to produce fibers according to at least one embodiment of the present invention using a volumetric drainage regime.

FIG. 17 is a high speed photograph of a fluid jet generated using a pendent drop nozzle embodiment of an apparatus to produce fibers according to at least one embodiment of the present invention using a surface drainage regime.

FIG. 18 is a high speed photograph of a fluid jet generated using a needle-tip nozzle embodiment of an apparatus to produce fibers according to at least one embodiment of the present invention.

FIG. 19 is three SEM images of polyvinyl pyrrolidone (“PVP”) nanofibers made using a needle-tip nozzle of 1.2 mm of internal diameter at gas jet pressures of 10 psi, 20 psi, and 30 psi, respectively, according to at least one embodiment of the present invention.

FIG. 20 is a schematic diagram showing the dependence of polymer solution viscosity (μ) and surface tension (γ) on polymer concentration ratio (C/C*). Also presented are images of the fibers obtained from a needle-tip nozzle at various capillary number values.

FIG. 21 is a schematic diagram showing several possible morphological forms of nanofibers from two immiscible polymers as function of solvent evaporation rates. The diagonal band corresponds to close solvent evaporation rates and nanofibers of ideal IPN morphology. Off-diagonal bands represent unequal solvent evaporation rates and nanofibers with side-by side and core-shell morphologies.

FIG. 22A-C are three TEM images of fibers produced from blends of PVP/polyvinyl acetate (“PVAc”) (1:1 wt/wt) showing fibers with (A) interpenetrating morphology made using methanol and ethylacetate as solvents, (B) side-by-side morphology made using isopropanol and ethylacetate as solvents, and (C) core-shell morphology made using 1-butanol and ethylacetate as solvents. Darker and lighter regions in B and C represent respectively PVP and PVAc.

FIG. 23 is a schematic representation of an apparatus to produce fibers according to at least one embodiment of the present invention using an array of wall-anchored nozzles.

FIG. 24 is a schematic representation of the overall apparatus to produce fibers according to at least one embodiment of the present invention using an array of needle-tip nozzles.

FIG. 25 is a schematic representation of the overall apparatus to produce fibers according to at least one embodiment of the present invention using an array of capillary tube nozzles.

FIG. 26 is an SEM image of the fibers of polyethylene oxide of Example 1 produced using a needle-tip nozzle.

FIG. 27 is an SEM image of the fibers of polyethylene oxide of Example 2 produced using a wall-anchored nozzle.

FIG. 28 is an SEM image of the fibers of polyvinyl pyrrolidone of Example 3 produced using a needle-tip nozzle.

FIG. 29 is an SEM image of the fibers of polyvinyl pyrrolidone of Example 4 produced by using a capillary tube nozzle

FIG. 30 is an SEM image of fibers of Example 5 produced using a co-axial wall-anchored nozzle.

FIG. 31 is a TEM photograph of the fiber of Example 5 produced using co-axial wall-anchored nozzle. The darker color shows the polyvinyl pyrrolidone in the core and lighter gray shows polyethylene oxide in the shell.

FIG. 32A-C are three SEM images of fibers produced from solutions of: (A) PEO 6% w/w in ethanol, (B) PVP 6% w/w in ethanol, (C) PVAc 6% w/w in ethyl acetate as set forth in Example 7.

FIG. 33 is an SEM image of fibers produced from a solution of PVP 2% w/w in ethanol as set forth in Example 7.

FIG. 34 is an SEM image showing fibers of Example 8 having a side-by-side morphology formed according to at least one embodiment of the present invention using 6% w/w of PEO in ethanol and 6% w/w of PVP in ethanol.

FIG. 35 is an SEM image showing of Example 8 having a side-by-side morphology formed according to at least one embodiment of the present invention using PVAc 6% w/w in ethyl acetate, and PEO 6% w/w in ethanol.

FIG. 36 is an SEM image showing of Example 9 formed according to at least one embodiment of the present invention using a blend of PEO and trisilanol isobutyl POSS in ethanol.

FIG. 37 is an SEM image showing of Example 9 having a core and shell morphology formed according to at least one embodiment of the present invention using blend of PEO and trisilanol isobutyl POSS in the core and PVAc in the shell.

FIG. 38 is a TEM image showing the PVP core and the PEO shell in a section of the fiber of Example 9 formed according to at least one embodiment of the present invention.

FIG. 39 is an SEM image of fibers of Example 10 produced according to at least one embodiment of the present invention from a PVP/PVAc solution having a 1:1 wt/wt ratio of isopropanol and ethylacetate.

### DETAILED DESCRIPTION OF THE ILLUSTRATIVE EMBODIMENTS

The present invention is directed to apparatus and methods for making multi-component microfibers and nanofibers and non-woven fiber mats thereof. In some embodiments, the fibers have diameters ranging from 10 nm or more to 3000 nm or less. In some embodiments, the fibers are made of more than one component and have one or a mix of the following morphologies: core-sheath, side by side, stratified and/or interpenetrating structures. In some embodiments the multi-component fibers are made from two spinnable fluids and in other embodiments the multi-component fibers are made from a single spinnable solution having two different material dissolved within. Unlike certain prior art processes, the present invention does not involve application of an electrical charge to the spinnable fluid to produce the fibers and, as a result, the solvent selection is not limited to those solvents conducive to being electrically charged.

As used herein, the terms “spinnable material”, “materials” and “components for forming fibers” may be used interchangeably throughout this specification without any limitation and refer to any material that can be formed into fibers. The term “spinnable material” is distinct from the term “spinnable fluid,” defined below, in that it is refers to the material that will become solidified into the nanofibers, rather than the fluid that is used to create the nanofibers.

As used herein, the terms “spinnable fluid,” and/or “the fluid” refers to any fluid containing or comprising one or more polymers or other “spinnable materials” that can be mechanically formed into cylindrical or other long shapes by stretching and then solidifying the liquid or material. This solidification can occur by, for example, cooling, chemical reaction, coalescence, or removal of a solvent. Examples of spinnable fluids include molten pitch, polymer solutions, polymer melts, polymers that are precursors to ceramics, and molten glassy materials. “Spinnable fluids” are often comprised of one or more “spinnable materials” and one or more solvents. As those skilled in the art will appreciate, a variety of materials can be employed to make fibers including pure liquids, solutions of fibers, mixtures with small particles and biological polymers.

The terms “pressurized gas” and “compressed gas” may be used interchangeably throughout this specification without any limitation and refer to gas held under pressure greater than atmospheric pressure. Further, the terms “stream of pressurized gas,” “flow of pressurized gas,” “jet of pressurized gas,” and/or “gas jet” may be used interchangeably throughout this specification without any limitation and refer to a stream of pressurized gas having a predetermined pressure and velocity that is used to make fibers as described herein.

The terms “core-shell” and “core-sheath” may be used interchangeably throughout this specification without any limitation and refer to any multi-component fiber morphology wherein the components are segregated so that a first spinnable materials forms a generally solid linear core and a second spinnable material surrounds the core and substantially covers the generally solid linear core, much like insulation on a wire.

As used here in, “fiber conglutination” or “conglutination” refers to the adhesion and or joining of newly formed fibers with fibers previously produced to form a three dimensional fiber structure with fibers joined to each other.

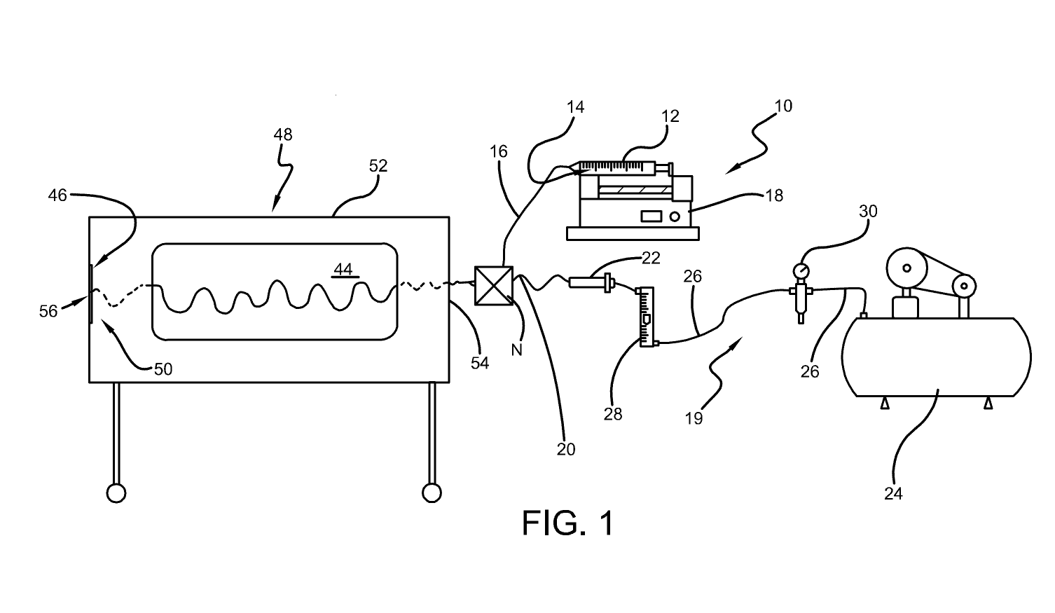

The general outline of a fiber making apparatus in accordance with this invention is shown in FIG. 1 and designated by the numeral 10. The apparatus 10 includes a reservoir 12 holding a spinnable fluid 14. The spinnable fluid 14 is pumped from the reservoir 12 through fluid tubes 16 to one of three types of nozzles, which will be individually disclosed herein, but are represented in FIG. 1 by the letter N. The fluid can be pumped by any suitable means, though here it is achieved by means of a syringe pump 18. The pumping of the spinnable fluid 14 can be practiced as in prior electrospinning arts and is a process generally known to those of ordinary skill in the art. However, unlike the electrospinning process, in the present apparatus and method, no charging of the spinnable fluid is necessary to form fibers. Instead, the fluid is acted upon by pressurized gas stream 20 generated at a gas tube 22. The pressurized gas stream 20 can be formed by any suitable means, but here is shown formed by means of a compressor 24 forcing the gas through a conduit 26 having a flow meter 28 and pressure gauge 30 to regulate the flow rate and pressure of the gas stream 20. The pressurized gas stream 20 acts on the spinnable fluid to create fibers, as will be described more fully below.

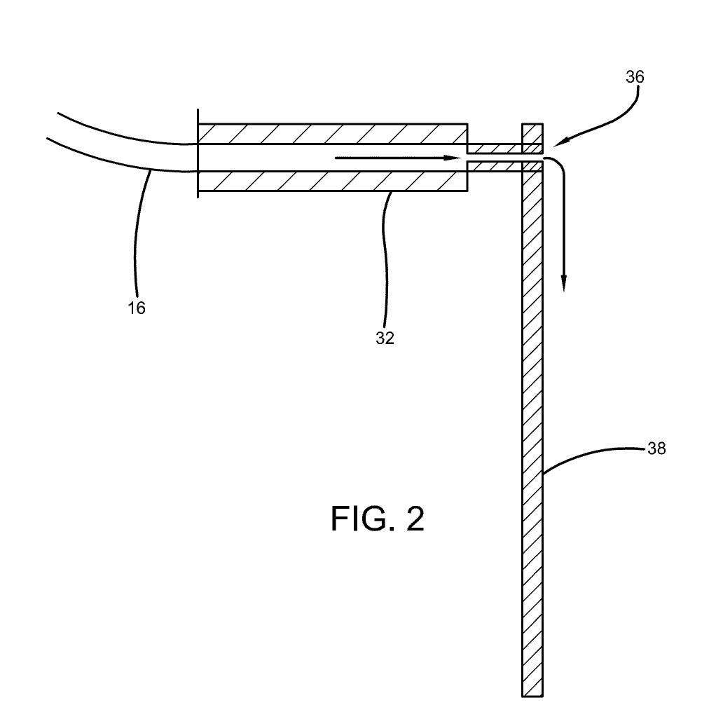

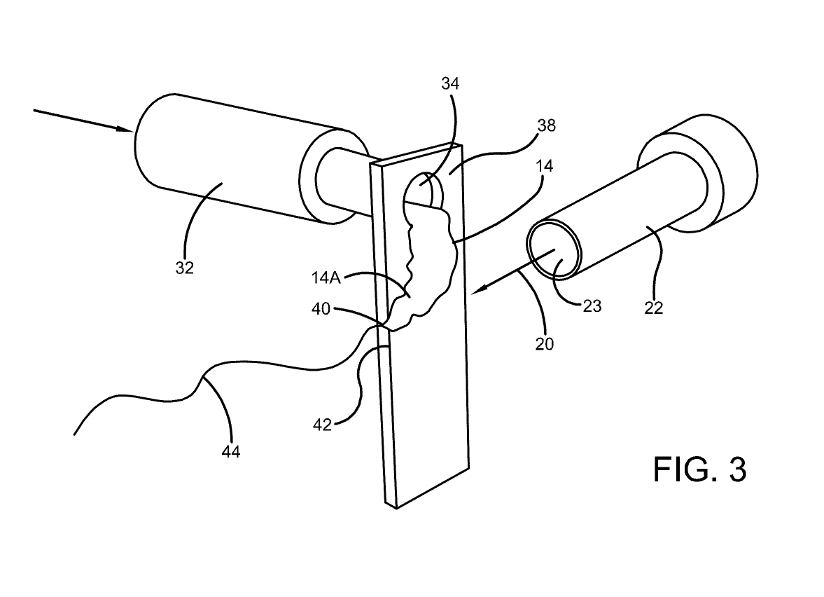

One type of nozzle N is a wall-mounted nozzle shown in FIGS. 2 and 3 and designated by the numeral 32. The spinnable fluid 14 exits the wall-mounted nozzle 32 through nozzle end opening 34 at an opening 36 of a solid surface 38 to flow down the solid surface 38 where the stream of pressurized gas 20 to blows across the spinnable fluid 14 thus causing the spinnable fluid 14 to form a fluid jet 40, similar to the jet formed from what is known as the “Taylor cone” in traditional electrospinning procedures. These jets 40 may erupt from waves formed in the spinnable fluid under the influence of the pressurized gas or at the edge 40 of the solid surface 38. As the fluid jet 40 moves under the influence of the pressurized gas 20 it lengthens and thins, eventually solidifying into a long thin fiber 44. The fiber thus formed is collected, typically as a non-woven fabric on a collection screen 46. In FIG. 1, a more specific collection area 48 is shown, but the invention is not limited thereto or thereby.

As shown in FIG. 1, the collection area 48, includes a collection screen 46 for collecting fibers 44 formed as the one or more spinnable fluids solidify after leaving the solid surface 38, thus forming a nonwoven fiber mat 50. In one embodiment, the fiber collection area 48 may be a fiber collection box 52 having a first opening 54 and a second opening 56, as shown in FIG. 1. In this embodiment, as the fibers form, they pass through the first opening 54 of the fiber collection box 52, are carried by the force of the stream of pressurized gas 20 to the other end of the fiber collection box 52, and collected on a collection screen 46 placed over the second opening 56 of the fiber collection box 52.

As should be apparent to one of ordinary skill in the art, the fiber collection area 48 need not be the fiber collection box 52 shown in FIG. 1. The nanofiber collection area 48 need only introduce a collection screen 46 or other similar structure into the stream of pressurized gas 20 to catch the fibers at a fixed distance from the nozzle. While not required, however, the fiber collection area 48 preferably shields the stream of pressurized gas 20 containing the fibers 44 from air currents that could disrupt the stream and cause some or all of the fibers to miss the collection screen 46.

It should be understood that collection screen 46 can be any type of cloth or mesh or the like that will catch the fibers, while letting some or all of the stream of pressurized gas 20 to pass through. It is generally sized to substantially cover the second opening 56 of fiber collection box 52, but may be any size provided it is large enough to catch substantially all of the fibers being produced. Suitable materials for the collection screen 46 include cloth, fiberglass, or wire mesh but are not limited thereto. In one embodiment the mesh size is 0.5 mm. In one embodiment, collection screen 46 may be a three dimensional unit (as opposed to a two dimensional screen) that may be rotated as it catches the fibers to form continuous non-woven mats of fibers.

Each of the reservoirs 12 may be temperature controlled using any suitable method known in the art so that the spinnable fluid kept therein is at an optimal temperature for forming fiber of the intended length, width, and morphology. In one embodiment, one or more reservoirs 12 are housed within a manual or motorized syringe pump 18.

As set forth above, motorized syringe pump 18 pumps the spinnable fluid 14 through the wall-mounted nozzle 32 at a predetermined feeding rate. In some embodiments, the feeding rate of the spinnable fluid, first spinnable fluid or second spinnable fluid through the nozzle is from about 0.1 mL per minute to about 10.0 mL per minute. In some embodiments, the feeding rate of the spinnable fluid, first spinnable fluid or second spinnable fluid through the nozzle 32 is from about 0.3 mL per minute to about 2.0 mL per minute.

The solid surface 38 may be made of any material suitable to the temperature, viscosity, and composition of the spinnable fluids including, for example, certain metals, ceramics, or plastic. It should be understood that whatever material is selected for the solid surface 38, it should be thick enough so as to not deform when acted on by the gas jet as described below. Solid surface 38 is generally expected to be oriented so that any spinnable fluid 14 on the solid surface will both cling to the solid surface 38 and flow down the solid surface 38 under the force of gravity. However, it should be understood that solid surface 38 need not be so oriented so long as any spinnable fluid 14 will stay on the surface 38 long enough to be acted upon by the gas jet, as set forth below.

Solid surface 38 may be flat, curved, or have periodic undulations and may also have sub-millimeter sized surface guiding features to direct some or all of the one or more spinnable fluids as they move down and/or across the solid surface 38. In one embodiment, solid surface 38 is substantially flat. In another embodiment, solid surface 38 may be slightly curved and may have a radius of curvature of from about 1 to about 100 millimeters.

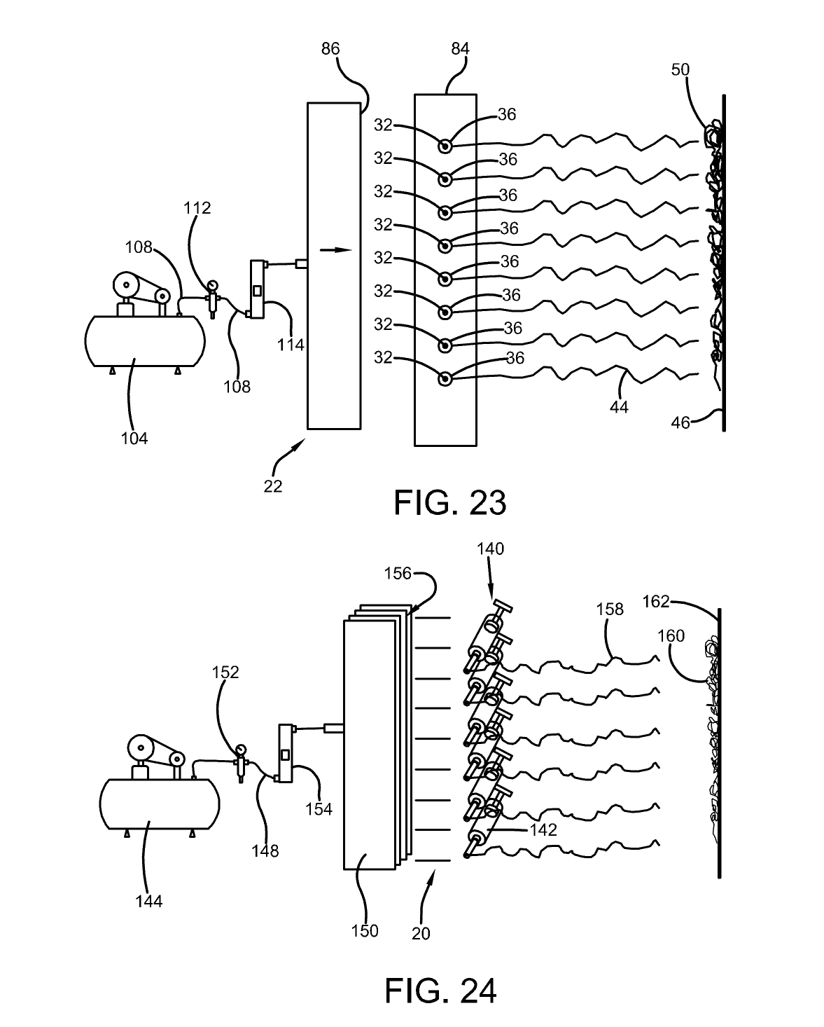

The size (i.e. surface area) of the solid surface 38 may be varied depending upon the number of nozzles used and their location, the composition and characteristics of the spinnable fluid 14 and the size of the fibers sought to be produced, among other factors. It should also be understood that in embodiments where an array of nozzles is used as shown in FIG. 23, the surface area of the solid surface 38 should to be large enough to accommodate the entire array of nozzles. In one embodiment, the surface area of the solid surface 38 is approximately 2 cm².

It should also be appreciated that, while the overall size of the solid surface 38 is not, by itself, of great importance, the distance that the fluid 14 travels from the nozzle 32 (and opening 36) to the edge 42 of the solid surface 38 is important to size and morphology of the fibers to be produced. If the distance is too short, the sheets of fluid 14A acted upon by the stream of pressurized gas 20 (see below) will be too thick when they reach the edge 42 of the solid surface 38 and the fibers formed, if any, will be too thick. If, on the other hand, the distance is too great, the sheets of fluid 14A acted upon by the stream of pressurized gas 20 may solidify before fibers can be formed. It has been found that, all other things being equal, fibers of smaller diameters will be formed when the openings 36 are further from the edge 42 of the solid surface 38 as compared to apparatus where the openings 36 are closer to the edge 42 of the solid surface 38. It should be appreciated that the optimum distance from the end opening 34 of the nozzle 32 to the edge 42 of the solid surface 38 will depend upon the composition and characteristics of the spinnable fluid 14 chosen, the temperature, and the size of the fibers sought to be produced, among other factors. In some embodiments this distance is from about 5 mm or more to about 30 mm or less. In other embodiments, this distance is from about 8 mm or more to about 15 mm or less.

The preferred size and shape of nozzle end opening 34 is variable and, as should be apparent, may depend upon the temperature, viscosity, and composition of the spinnable fluid 14 to be used and the desired length, diameter and morphology of the fibers to be created. In some embodiments, the nozzle opening 34 may be any suitable size including for example from about 0.3 mm or more to about 4 mm or less, and is preferably from about 0.5 mm or more to about 1.5 mm or less. In some embodiments, the nozzle opening 34 may be of any suitable shape, including, for example circular, elliptical, scalloped, corrugated, fluted, rectangular, square, or slotted, among others.

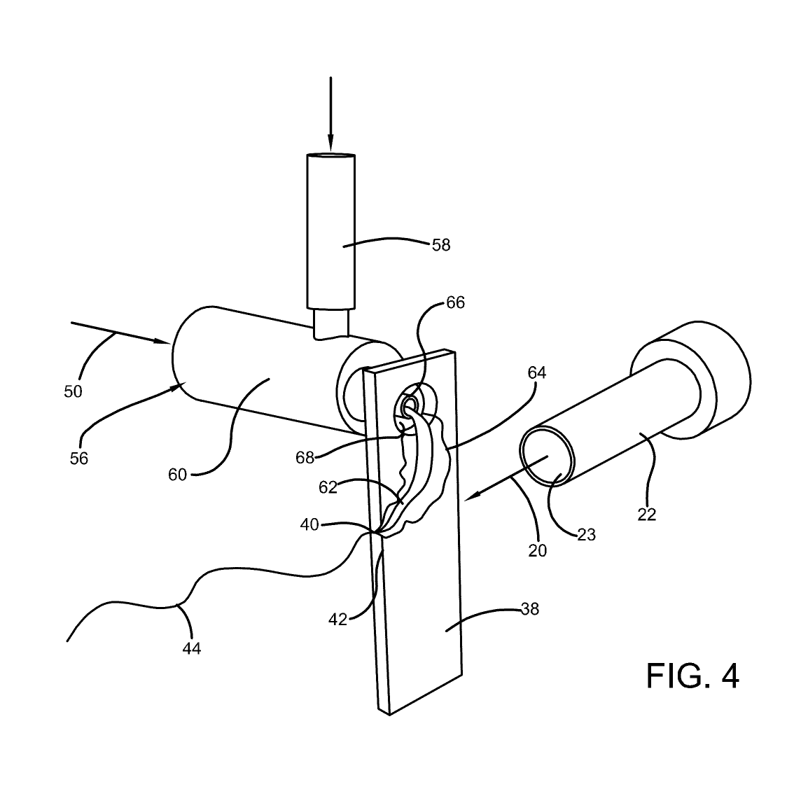

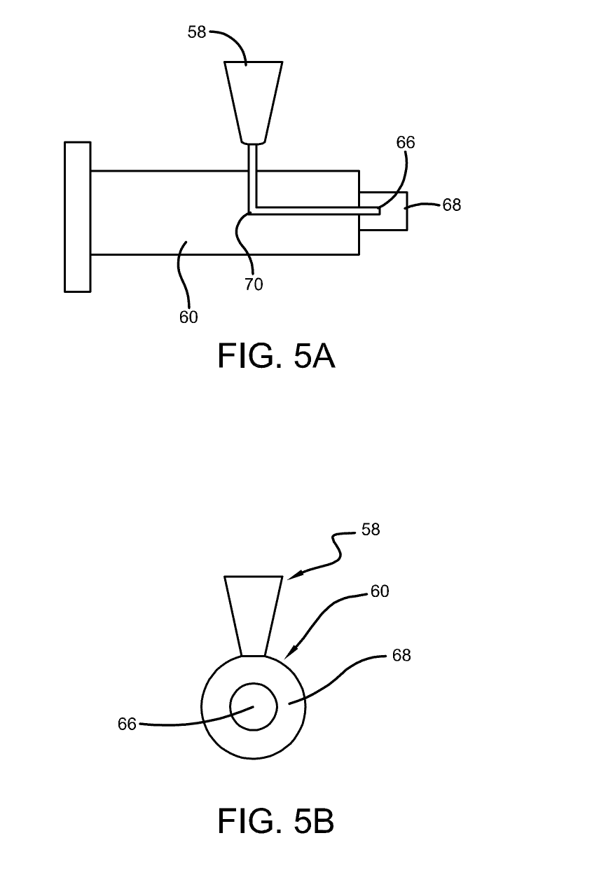

The wall-mounted nozzle 32 can carry a single spinnable fluid or a mixture of spinnable fluids. With mixtures, fibers of particular morphology are possible. Thus, the fluid 14 of FIG. 3 could be a mixture of two or more spinnable fluids all traveling through the same nozzle 32. Alternatively, as shown in FIG. 4, wall-mounted nozzle could provide separate spinnable fluid through concentric tubes to deposit a mixture of spinnable fluids on the solid surface 38. One such embodiment is shown in FIGS. 4, 5A and 5B, wherein the wall-anchored nozzle arrangement of the present invention further comprises a first nozzle 58 and second nozzle 60. The first nozzle 58 receives a first spinnable fluid 62 and the second nozzle 60 includes receives a second spinnable fluid 64, and the exit ends 66, 68 of the first and second nozzles 58, 60 are coaxial, here shown with the second nozzle 60 surrounding the first nozzle 58. In FIGS. 5A and 5B, the coaxial structure is achieved by extending the first nozzle 58 into the second nozzle 60 and including a bend 70 to extend the first nozzle 58 for a central position with nozzle 60 forming an annulus around the first nozzle 58. The exits of the nozzles 58 and 60 can also be made to be non-concentric, i.e., with the exit of first nozzle 58 off center with respect to the exit of the second nozzle 60. Referring back to FIG. 4, the first nozzle 58 feed a first spinnable fluid 62 and the second nozzle 60 feeds a second spinnable fluid 64, with the second fluid 64 tending to be enveloped by the first fluid 62. Upon blowing with the gas stream 20, fibers with core and sheath morphologies tend to be produced.

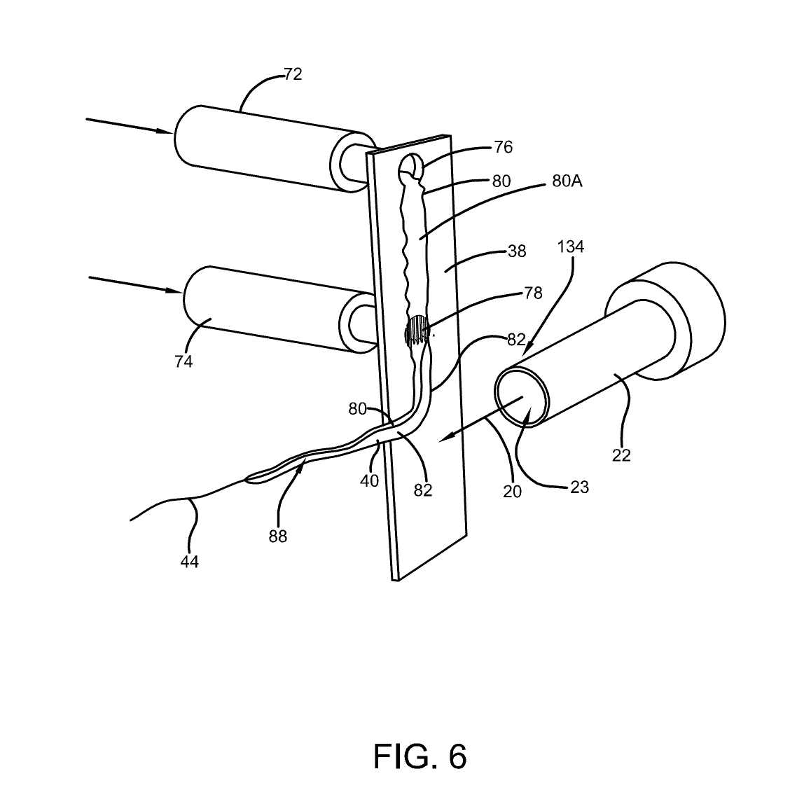

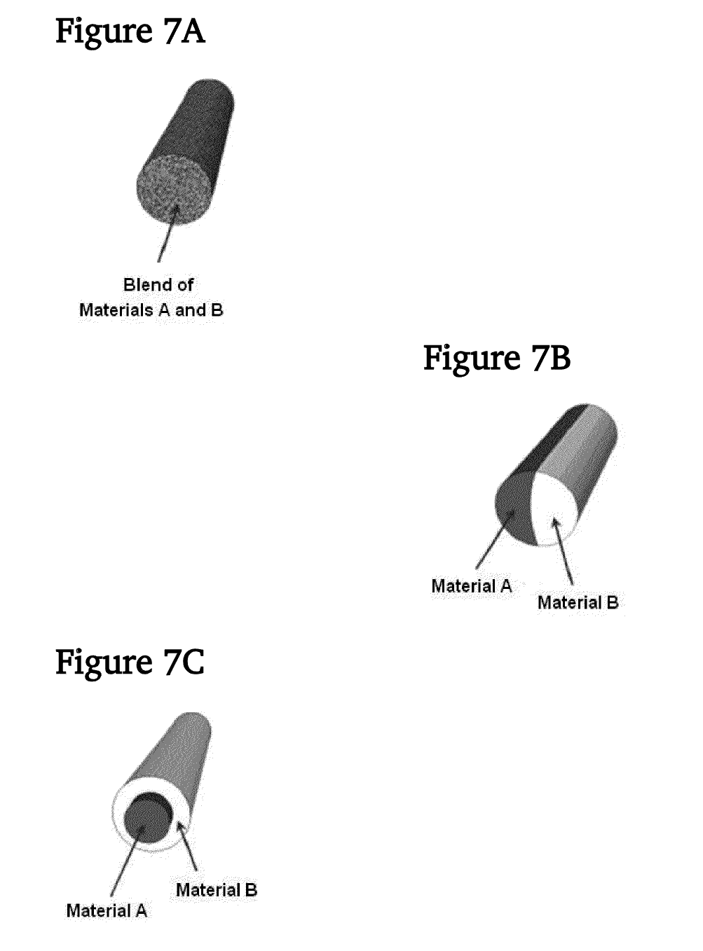

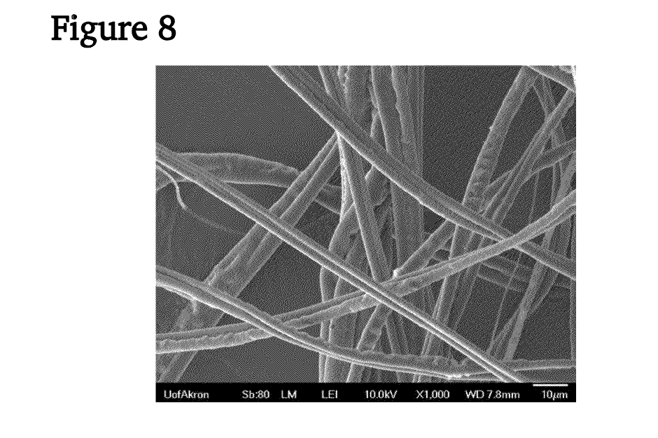

With reference to FIG. 6, it can be seen that the solid surface 38 can include a plurality of wall-mounted nozzles 32, as at wall-mounted nozzles 72 and 74 extending to respective openings 76 and 78 oriented so that the first spinnable fluid 80 flowing out of first (upper) nozzle 72 and onto solid surface 38 will tend to flow over the second (lower) opening 78 and finally over the second spinnable fluid 82 deposited upon the solid surface 38 from the second (lower) nozzle. The first and second spinnable fluids 80 and 82 are acted on by a gas jet 20 as described above. The flow of pressurized gas reduces the thickness of the layers as set forth above, forces the two layers together, and then detaches the layers into fibers having side-by-side morphologies as shown in FIGS. 7B and 8 or core-sheath morphologies as shown in FIG. 7C.

Though shown offset with one opening 76 above the other opening 78, it should be appreciated that the opening could be offset horizontally, with the pressurized gas forcing the respective spinnable solutions to mix. A combination of vertical and horizontal staggering can also be practice, as can a large plurality of nozzles and openings as opposed to the two shown.

As set forth above, it should also be appreciated that as the two or more spinnable fluids flow down the solid surface 38 they may be guided into contact with each other by gravity, the location of the openings 36 and/or the shape and surface characteristics of the of the solid surface 38, where they may be acted upon by the stream of pressurized gas stream 20 (see below) to form multi-component fibers having a variety of useful morphologies. Depending on the relative viscosities of the two fluids, either side-by-side and core and sheath fibers may be produced using this method. If the first and second spinnable fluids 80, 82 have similar viscosities, the first spinnable fluid 80 and second spinnable 82 will separate out into two columns as the fiber forms and the resulting multi-component fibers will tend to have a side-by-side morphology as shown in FIG. 7B and 8. If, on the other hand, there is a great differential between the viscosities of the first and second fluids 80, 82, the fluid with lower viscosity will tend to encapsulate the fluid having the higher viscosity resulting multi-component fibers tending toward a core-sheath morphology as shown in FIG. 7C. In one such embodiment the difference between the viscosity of the two spinnable fluids is 2 orders of magnitude or more.

In one embodiment, the first spinnable fluid 80 and second spinnable fluid 82 are immiscible. In another embodiment, the first spinnable fluid 80 and second spinnable fluid 82 are partially miscible. In yet another embodiment, the first spinnable fluid 82 and second spinnable fluid 84 are miscible.

In accordance with another embodiment, the nozzle N of FIG. 1 can be provided as an array of nozzles 84, as generally shown in FIG. 23. In this embodiment, the solid surface 38 is elongated and has a plurality of openings 36 to accommodate an array of nozzles 84. Each of the one or more spinnable fluids (not shown) are brought to one or more of the nozzles 32 and onto solid surface 38 as described above. The pressurized gas stream 20 delivered from a slit shaped exit of gas tube 2 forms a fluid jet from each nozzle 32, in the manner discussed above. The fluid jets travel and form fibers that can be collect to form a non-woven mat 50 of fabric on a collection screen 46.

It should also be apparent that the one or more nozzles 32 may also be heated so that the spinnable fluid passing through the nozzles 32 is at an optimal temperature for forming fibers of the intended length, width, and morphology.

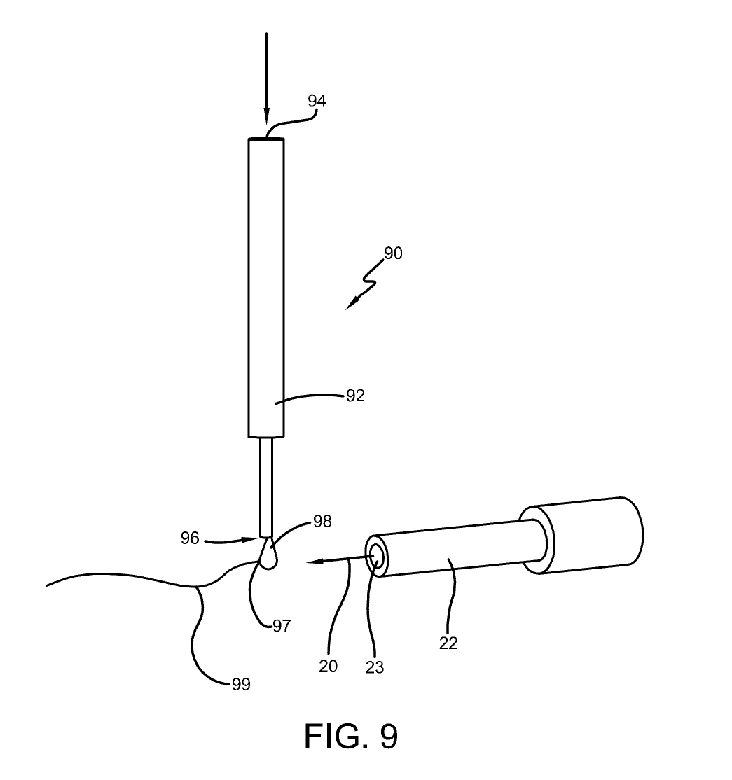

In yet another embodiment, nozzle N of FIG. 1 can be a capillary tube nozzle 90 as disclosed with reference to FIGS. 9, 16, 17 and 25. The capillary tube nozzle 90 of the present invention comprises a capillary tube 92 having a first (supply) end opening 94 connected to reservoir 12 by one or more fluid tubes 16 (in the same way as nozzle 17 above) and a second (exit) end opening 96. Capillary tube 92 may be made of any conventional material, including, for example, glass or heat resistant plastic.

The optimal inner diameter of the capillary tube 92 will depend on the specific characteristics of the spinnable fluid 14 chosen, the desired diameter and length of the fibers sought to be produced, and on the temperature, among other factors. The capillary tube 92 must be sized to permit the formation of a pendant drop 98 extending from the opening 96, and this will depend upon the size of the opening 96 and the spinnable fluid, which must have sufficient surface tension to hold the pendant drop without separation. In some embodiment, the diameter of the capillary tube may be from about 0.5 mm or more to about 4 mm or less, and, in other embodiments, from about 1.0 mm or more to about 2.0 mm or less. In one embodiment the end opening 96 of capillary tube 92 has an internal diameter of 1.0 mm. The capillary tube nozzle 90 may also be heated so that the spinnable fluid passing through the capillary tube nozzle 90 is at an optimal temperature for forming fibers of the intended length, width, and morphology.

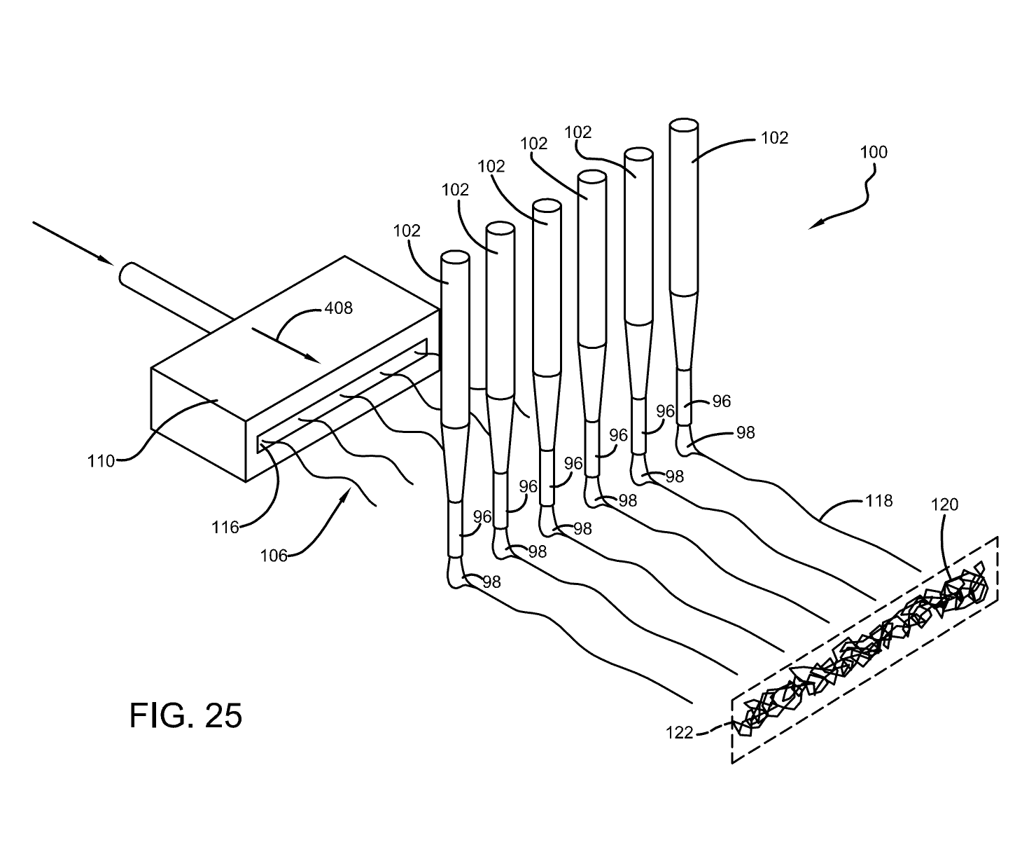

With reference to FIG. 25, an array of capillary tube nozzles 100 can be employed. Each of the one or more spinnable fluids (not shown) are brought to each of the one or more of the capillary tube nozzles 102, as described above. A source of pressurized gas 104 provides a stream of pressurized gas 106 through tubing 108 to gas tube 110. The velocity and pressure of the gas is controlled by a pressure gage 112 and flow meter 114. As can be seen, the gas tube 110 is a long slit 116 that provides a stream of pressurized gas 106 to each of the one or more capillary tube nozzles 102 to form fibers 118 in the manner discussed above. The fibers 118 travel with the gas jet 106 until they form a mat on fibers 120 on collections screen 122.

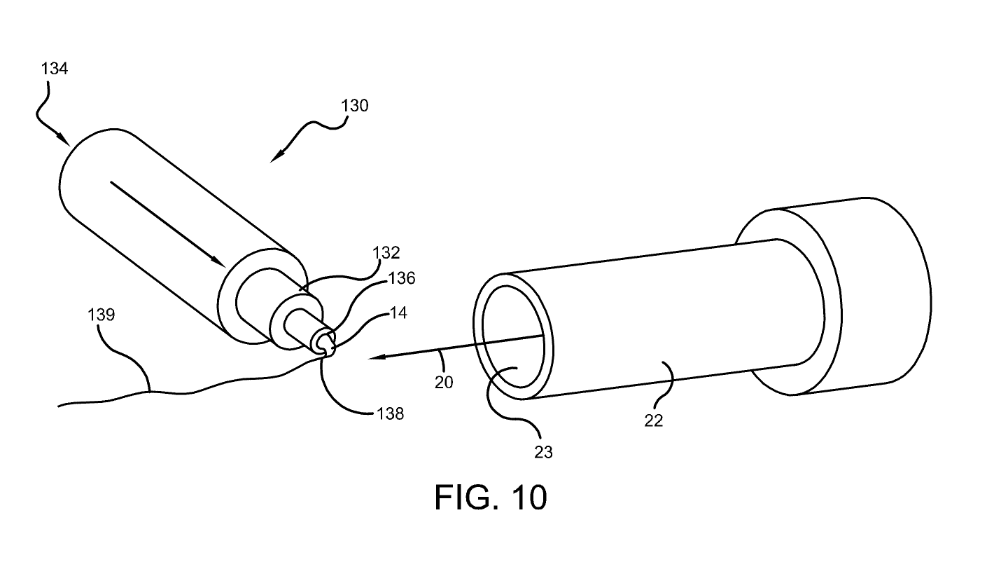

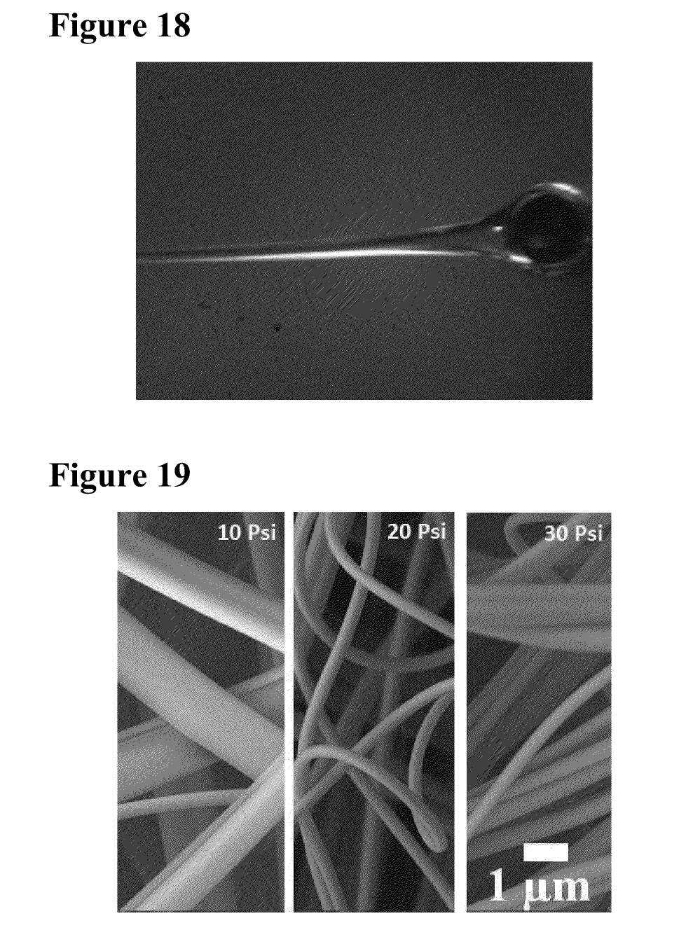

In yet another embodiment, nozzle N of FIG. 1 can be a needle-tip nozzle as shown in FIGS. 10, 18, and 24 and designated by the numeral 130. The needle-tip nozzle 130 comprises a needle-tip 132, a first (supply) end opening 134 connected to reservoir 12 by one or more fluid tubes 16 (in the same way as nozzle 32 above), and a second (exit) end opening 130. In one embodiment, needle-tip nozzle 130 may be a non-sharp needle tip available for purchase from Jensen Global. Inc.

It should also be understood that the optimal inner diameter of the needle tip 132 will depend on the specific characteristics of the spinnable fluid 14 chosen, the desired diameter and length of the fibers sought to be produced, and on the temperature, among other factors. In some embodiments, the diameter is from about 0.1 mm or more to about 3.0 mm or less, and, in some embodiments, from about 0.3 mm or more to about 1.22 mm or less. In one embodiment the needle-tip 132 has an internal diameter of 1.22 mm. The needle-tip nozzle 130 may also be heated so that the spinnable fluid passing through the needle-tip nozzle 130 is at an optimal temperature for forming fibers of the intended length, width, and morphology.

As set forth above, motorized syringe pump 18 pumps the spinnable fluid 14 through the needle-tip nozzle 100 at a predetermined feeding rate. In some embodiments, the feeding rate of the spinnable fluid through the nozzle is from about 0.1 mL per minute to about 10.0 mL per minute. In some embodiments, the feeding rate of the spinnable fluid through the nozzle 32 is from about 0.3 mL per minute to about 2.0 mL per minute.

With reference to FIG. 24, an array of needle-tip nozzles 140 can be employed. Each of the one or more spinnable fluids (not shown) are brought to each of the one or more of the needle-tip nozzles 140, as described above. A source of pressurized gas 144 provides a stream of pressurized gas 146 through tubing 148 to gas tube 150. The velocity and pressure of the gas is controlled by a pressure gage 152 and flow meter 154. As can be seen, the gas tube 150 comprise a long slit 156 that provides a stream of pressurized gas to each of the one or more nozzles 142 to form fibers 158 in the manner discussed above. The fibers 158 travel with the gas jet 146 until they form a mat on fibers 160 on collections screen 162.

According to the present invention, fibers are produced using the apparatus of FIG. 1 and the capillary tube type nozzle N by the following method. As set forth above, a spinnable fluid 14 is brought to the capillary tube nozzle 90 by using the pumping device 18. Under controlled conditions, stable pendant drops 98 of spinnable fluids 14 of chosen sizes and composition may be formed at the exit opening 96 of a capillary tube nozzle 90 by the action of surface and viscous forces as shown in FIGS. 9, 16 and 17.

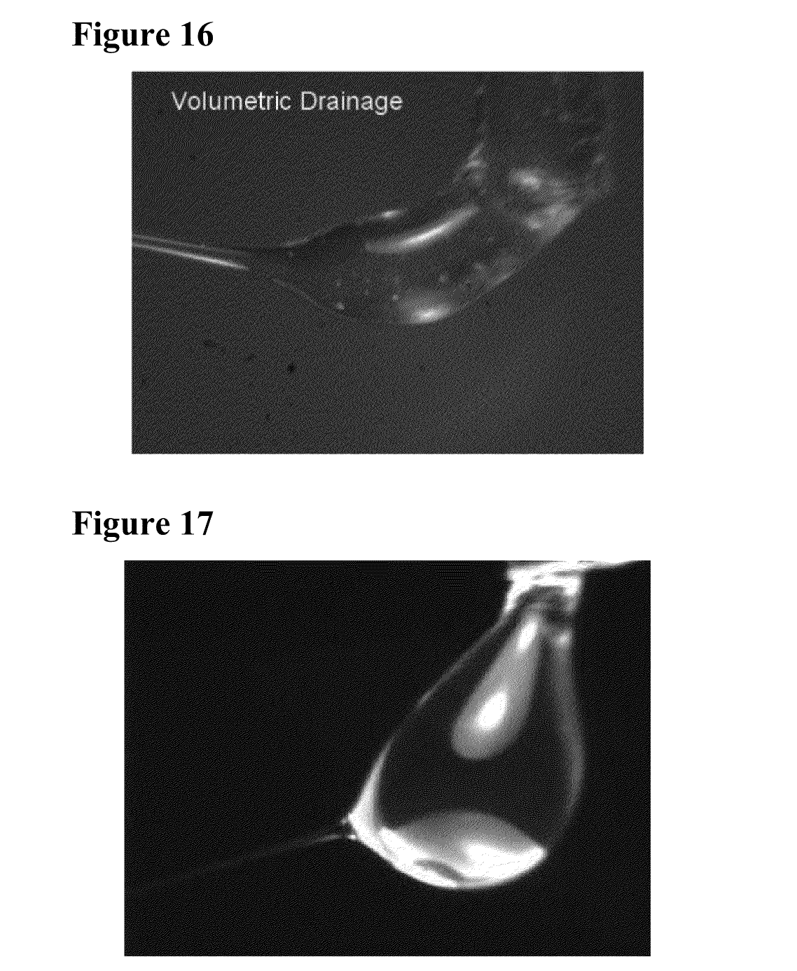

In this aspect of the invention, the pressurized gas source 19 provides a stream of pressurized gas 20 to the pendant drop 98 of spinnable fluid 14 at an angle of about 90 degrees to the capillary tube. As the stream of pressurized gas 20 flows over the drop, it generates a surface instability that propagates into a fiber jet 97 that is elongated and solidified into a thin fiber 99. (See FIGS. 16 and 17)

In addition, the velocity of the stream of pressurized gas 20 can be easily controlled to generate two different regimes of fiber formation. In a draining regime, the pendant drop 98 is totally deformed and fibers formed from the drop solution bulk are easily obtained. Under this regime, additives deposited in the spinnable fluid including, but not limited to, cells, colloids, or other polymer particles, may be encapsulated into the formed fiber. See FIG. 17. It has also been found that as the velocity of the gas jet increases, the diameter of fibers 99 becomes smaller until the force of the gas jet 20 becomes too strong and the pendant drop 98 is blown from the capillary tube 92, usually at about 10 psi. (See e.g. FIG. 19). Again, the velocity of the stream of pressurized gas 20 required for a draining regime will depend on the characteristics of the fluid 14 chosen, the flow rate of the fluid out of the capillary tube 90, the desired diameter and length of the fibers to be produced and the temperature, among other factors. In some embodiments, the velocity is from about 2.0 SCFM (standard cubic feet per minute) to about 2.5 SCFM. In some embodiments, the gas pressure may be from about 7 psi to about 10 psi. Similarly, the feeding rate of the fluid 14 out of the capillary tube nozzle 90 in the draining regime will depend upon the velocity of the stream of pressurized gas 20, the characteristics of the fluid 14 chosen, the temperature, and the desired diameter and length of the fibers to be produced, among other factors. In some embodiments, feeding rate of the fluid 14 through the capillary tube nozzle 90 may be from about 0.01 mL per minute to about 0.15 mL per minute. In another embodiment, the feeding rate of the fluid 14 out of the capillary tube nozzle 90 is from about 0.02 mL per minute to about 0.1 mL per minute.

Alternatively, a surface drag regime can be used to form fibers 99 from the fluid close to the free surface of the drop 98. See FIG. 16. Again, the velocity of the stream of pressurized gas 20 required for a surface drag regime will depend on the characteristics of the fluid 14 chosen, the flow rate of the fluid 14 out of capillary tube nozzle 90, the desired diameter and length of the fibers 99 to be produced and the temperature, among other factors, but in some embodiments it may be from about 0.8 SCFM (standard cubic feet per min) to 1.5 SCFM. Again, it has also been found that as the velocity of the gas jet 20 increases, the diameter of fibers 99 becomes smaller until the force of the gas jet 20 becomes too strong and the pendant drop 98 is blown from the capillary tube 92. (See e.g. FIG. 19). In some embodiments, the pressure of the gas jet is 4 psi. Similarly, the feeding rate of the fluid through the capillary tube for the surface drag regime, will depend upon the velocity of the stream of pressurized gas 20, the characteristics of the fluids 14 chosen, the temperature, and the desired diameter and length of the fibers to be produced, among other factors. In some embodiments, feeding rate of the fluid 14 through the capillary tube nozzle 90 may be from about 0.01 mL per minute to about 0.15 mL per minute. In another embodiment, the feeding rate of the fluid 14 out of the capillary tube nozzle 90 is from about 0.02 mL per minute to about 0.1 mL per minute.

The fibers produced by this method are then collected as set forth above.

According to the present invention, fibers are produced using the apparatus of FIG. 1 and the needle-tip type nozzle N by the following method. The spinnable fluid is brought to the needle-tip nozzle 130 in the manner described above with respect to wall mounted nozzle and pendent drop nozzles. In this method, however, the spinnable fluid 14 is contacted by the gas jet 20 as soon as it leaves the needle-tip nozzle 130, i.e., a pendant drop is not formed. As the gas jet 20 contacts the fluid 14, which is stretched and pulled into a fluid jet 138, which solidifies to form a fiber 139 in the manner described above. It has also been found that as the velocity of the gas jet 20 increases, the diameter of fibers 139 becomes smaller until the force of the gas jet becomes too strong and disturbs the production of fibers. (See e.g. FIG. 19). The fibers 139 produced by this method are then collected as set forth above.

Further, it is seen that there is no significant difference between the fibers produced using a wall-anchored nozzle (FIGS. 1, 3, 4 and 6) or a needle-tip nozzle (FIG. 10) if process parameters are similar. On the other hand, the nozzle configuration based on pendant drops (FIG. 9) give rise to fibers with a much smaller mean diameter (˜200 nm) at low air jet pressures up to about 10 psi. At a higher pressure of the air jet the pendent drop becomes unstable.

Spinnable fluid 14 may be any solution or dispersion of a spinnable material in a solvent or in a liquid form capable of or susceptible to forming fiber threads. Spinnable material may include polymeric, carbonaceous and ceramic materials, among others. The class of materials suitable for this process are generally soluble in a variety of solvents, have a high enough molecular weight to form polymer chain entanglements, and have a suitable process for removing solvent or stabilizing the fibers that are produced.

The polymeric material could, for example, be selected from the group of polyethylene oxide, polyvinyl pyrrolidone, polyvinyl acetate, nylon, polyurethane, polybenzimidazole, polycarbonate, polyacrylonitrile, polyvinyl alcohol, polylactic acid, polyethylene-co-vinyl acetate, polymethyl metacrylate, polyaniline, collagen, gelatin, silk-like polymer, polyvinylcarbazole, polyethylene terephtalate, polyacrilic acid, polystyrene, polyiamide, polyninylchlororide, cellulose acetate, polyacrilamide, polycaprolactone, polyvinylidene fluoride, polyether imide, polyethylene, polypropylene, polyethylene naphtalate, Acrylic polymers such as poly(acrylic acid), poly(methyl methacrylate) polyacrylonitrile, poly(ethyl cyanoacrylate) and polyacrylamide, amino polymers, fluoropolymers such as poly(tetrafluoroethene), poly(1,1-difluoroethene) and poly{oxycarbonyloxy-1,4-phenylene [bis-trifluoromethyl)methylene]-1,4-phenylene)}, furan polymers, phenolic polymers, polyacetylene, polyaniline, polybetaine, polybismaleimide, polydiacetylene, polydiene, polyolefin, polypyrrole, polythiophene, polyvinyl acetal, polyvinyl ester, polyvinyl ether, polyvinyl halide, polyvinyl ketone, styrene polymer, vinyl polymers, vinylidene polymers, polyamides, polyamide acid, polyamines, polyanhydrides, polybenzimidazole, polyazomethine, polybenzothiazole, polybenzoxazole, polycarbamate, polycarbodiimide, polycarbonate, polycarbosilane, polycyanurate, polyester, polyether, polyglatarimide, polyhydantoin, polyhydrazide, polyimidazole, polyimide, polyketone, polymetaloxane, polyoxadiazole, polyoxyarylene, polyoxymethylene, polyoxyphenylene, polyphenylene, polyphenylenemethylene, polyphenylenevinylene, polyphosphate, polyphophazene, polypyrrone, polyquinoline, polyquinoxaline, polysaccharide, polysilane, polysilazane, polysiloxane, polysilsesquioxane, polysulfide, polysulfonamide, polysulfone, polytetrazine, polythiadiazole, polythiazole, polythioether, polytriazine, polyurea, polyvinylene, or combinations thereof, and the like.

The carbonaceous materials could, for example, be selected from the group of mesophase pitch, polyacrylonitrile, coal tar or combinations thereof and the like. The ceramic precursors could be selected from the group of zirconium (IV) propoxide, titanium (IV) isopropoxide, yttrium nitrate hexahydrate, tetraethyl orthosilicate, zinc acetate, copper nitrate or a combinations of any of these with the polymeric materials set forth above, and the like.

Suitable solvents for use in spinnable fluids according to embodiments of the present invention could be a relatively volatile solvent at atmospheric pressure, for example, solvents selected from the group of Alkanes solvents such as petroleum ethers, ligroin, hexanes, heptane, and pentane; cyclic alkanes such as cyclohexane, and cyclopentane; aromatics solvents such as toluene, and benzene; ethers solvents such as diethyl ether, dimethyl ether, methyl ethyl ether, dimethoxyethane, diisopropylether, and dioxanes; alkyl halides such as tetrachloromethane, 1,1,2,2,-tetrachloroethane, 1,1,1,-trichloroethane, tetrachloroethylene, pentachloroethane, trichloroethylene, chlorobenzene, chloroform, dichloromethane, and methylenechloride; esters such as ethyl acetate, and butyl acetate; aldehydes and ketones such as acetone, methyl ethyl ketone and acetaldehyde; amines such as pyridine, ethylamine, diethanolamine, diethylenetriamine, methyl diethanolamine, and triethylamine; isocyanides such as methyl isocyanide; alcohols such as methanol, ethanol, isopropanol, butanol, n-amylalcohol, n-pentanol, n-butanol, tert-butanol, 2-methyl-2-propanol, 1,2-butanediol, 1,3-butanediol, ethylene glycol, triethylene glycol, 1,4-butanediol, isoamylalcohol, 3-methyl-1-butanol, 2-butoxyethanol, n-propylalcohol, 1,3-propanediol, furfuryl alcohol, glycerol, 1,5-pentanediol, propylene glycol, and 1-propanol; amides such as dimethyl formamide; carboxylic acids such as acetic acid, formic acid, butyric acid, and propanoic acid; nitriles such as acetonitrile; fluoro-containing solvents such as hexafluoro-2-propanol, and hexafluoroisopropanol; water, tetrahydrofurane (THF), inorganic acids such as sulfuric acid, and hydrochloric acid; sulfur containing solvents such as dimethyl sulfoxide, carbon disulfide and the like, and mixtures in different proportions of the solvents

Spinnable fluid 14 may also include one or more additives to be incorporated or encapsulated into the fibers. The additives can include any material sought to be incorporated or encapsulated into the fibers provided that: (i) the proposed additive is appropriately sized to be incorporated or encapsulated into the fibers; (ii) is a solid or will solidify upon formation of the fibers; and (iii) is dispersable in the solution such that it does not precipitate out of solution before the fiber can be formed. It should be understood that the amount of additives that can be included in the spinnable fluid 14 will depend upon the spinnable fluid 14, the particular additive or additives being used, and the size, length, and morphology of fiber sought to be produced. In one embodiment, the additives comprise up to about 30% of the spinnable fluid 14 by weight.

Additives may include, for example, insoluble nanofibers, dissolved substances, colloids, small crystals, fluid droplets or other particles that, when employed, are sequestered in the fiber when it forms and thereby available to provide useful functionality to the fibers and any device created therefrom. In one embodiment, the additive may be one or a plurality of sol-gel precursors soluble in the spinnable fluid 14. Examples include indium trichloride, indium tri(isopropoxide), titanium tetra(isopropoxide), and stannic chloride. In this embodiment, insoluble nanoparticles later form from the sol-gel precursors to reinforce the fibers and to make the fibers electrically and/or thermally conductive. As used herein, the term “gel-sol precursor” refers to mixtures of organic and inorganic material used to form inorganic particles inside the fibers due to chemical reactions occurring ant the time of fiber formation or after fiber formation. Examples include titanium dioxide, indium oxide, tin oxide doped indium oxide (also called indium tin oxide or ITO). In other embodiments, the additive may be one or a plurality of inorganic pigments. Examples include titanium dioxide, calcium carbonate, talc, Holland blue, etc.

In still other embodiments, the additives may be small molecules capable of exhibiting therapeutic benefits. The additive may be, for example, one or a plurality small molecules capable of exhibiting optical and electronic properties or stimuli for responsive behavior. Examples include azo dyes, liquid crystals, and organic crystals. In yet another embodiment, the additive may be one or more catalysts or catalytic precursors. Examples include rare earth elements, iron oxide, transition metal chlorides In another embodiment, the additive may be cells, organelles, and/or biomolecules, including, but not limited to, stem cells, peptides, proteins, lipids, metabolites and enzymes. In one embodiment, the additive is trisilanol isobutyl polyhedral oligomeric silsesquioxane (“POSS”) molecules.

The term “gas” as used throughout this specification, includes any gas, including air. Non-reactive gases are preferred and refer to those gases, or combinations thereof, that will not deleteriously impact the fiber-forming material. Examples of these gases include, but are not limited to, nitrogen, helium, argon, air, carbon dioxide, steam fluorocarbons, fluorochlorocarbons, and mixtures thereof. It should be understood that for purposes of this specification, gases will also refer to those super heated liquids that evaporate at the apparatus when pressure is released, e.g., steam. It should further be appreciated that these gases may contain solvent vapors that serve to control the rate of drying of the nanofibers made from polymer solutions. Still further, useful gases include those that react in a desirable way, including mixtures of gases and vapors or other materials that react in a desirable way. For example, it may be useful to employ oxygen to stabilize the production of nanofibers from pitch. Also, it may be useful to employ gas streams that include molecules that serve to crosslink polymers. Still further, it may be useful to employ gas streams that include metals or metal compounds that serve to improve the production of ceramics.

The gas may be compressed or otherwise pressurized to a pressure of from about 5 psi to about 100 psi, and is more preferably compressed or otherwise pressurized to a pressure of from about 10 psi to about 40 psi. In one embodiment, the pressurized gas is air and is brought up to pressure using a commercially available air compressor. A filter (not shown) may also be used to ensure that no foreign material enters the stream of pressurized gas 20.

The velocity (or flow rate) of the stream of pressurized gas 20 required to form the fibers will depend on the composition and characteristics of the one or more spinnable fluids 14 chosen and the size of the fibers to be produced, among other factors. In some embodiments, the flow rate is from about 0.05 cubic meters per second (m³/s) or more to about 0.5 m³/s or less, in other embodiments, from about 0.1 m³/s or more to about 0.2 m³/s or less. The gas or gasses used may also be heated using any suitable method known in the art. Heating the gas or gasses can serve to accelerate the removal the solvent(s) from the fibers and to create pores and wrinkles in the fibers.

The optimal distance between the exit opening 23 of gas tube 22 and nozzle N will depend on the composition and characteristics of the spinnable fluids 12 chosen and the desired diameter and length of the fibers to be produced. As one of ordinary skill in the art will appreciate, however, it is possible to deliver the pressurized gas to the spinnable fluid 14 at a given velocity and pressure from different distances by varying the velocity and pressure of the gas as it leaves the exit opening 23 of the gas tube 22. However, it is believed that since the speed of gas decreases rapidly upon leaving the exit opening 23 of gas tube 22, it is advantageous to keep the distance relatively short, in some embodiments, from about 3 to about 5 centimeters. It is also believed that a shorter delivery distance helps to keep the stream of pressurized gas 20 from diffusing before it can act on the spinnable fluid making it easier to control the direction and pressure of the gas jet 20 contacting the spinnable fluid 14. Not surprisingly, it has been found that all other parameters being equal, the diameter of the nanofibers produced increases with the distance between the exit opening 23 of the gas tube 22, until the gas tube 22 becomes too far from the spinnable fluid 14 to make fibers.

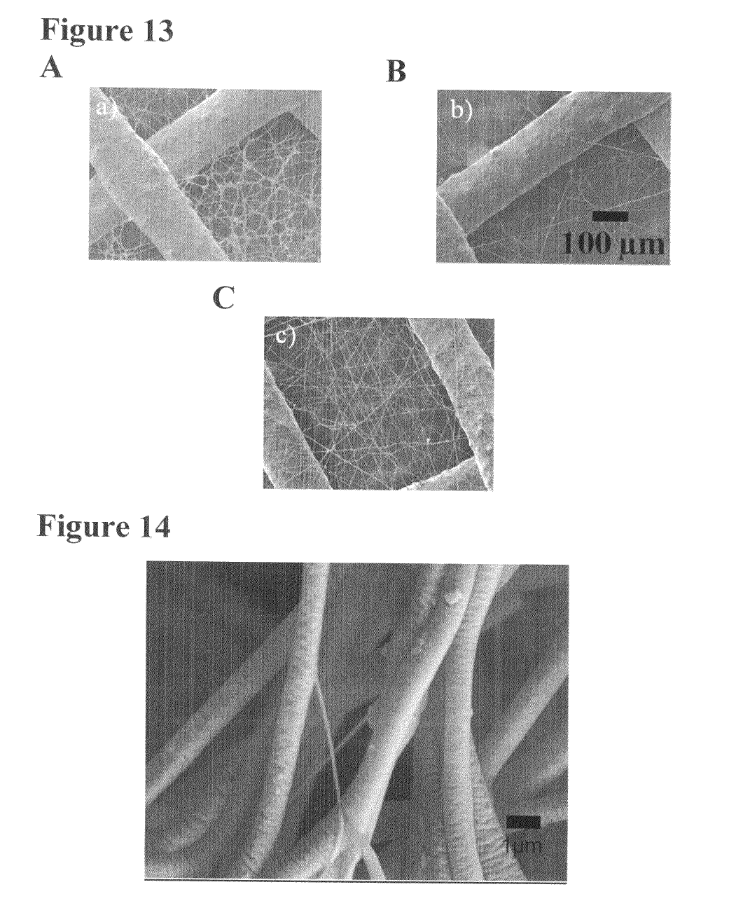

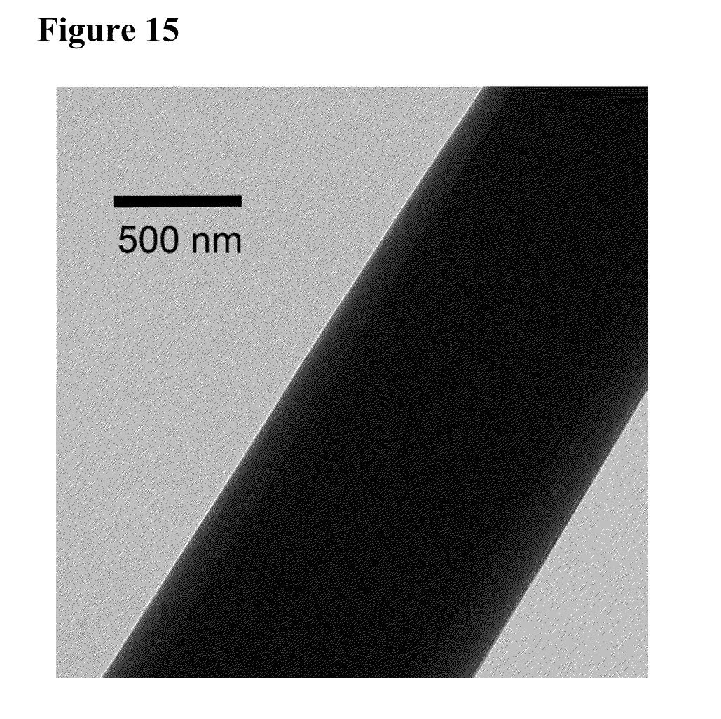

Further, it is believed that because the fibers 44 are in the process of solidifying as they leave the solid surface, fibers collected closer to the nozzle N will tend to stick together to varying degrees. To that end, fiber conglutination necessary to create three-dimensional webs, may be achieved by collecting fibers closer to the liquid jet 40. FIG. 13 shows three different degrees of conglutination of PEO fibers produced using a wall-anchored nozzle system at an air jet pressure of 10 psi for fibers collected at specified distances from the nozzle N. As can be seen in FIG. 13, the degree of fiber conglutination increases as the distance between the collection area and the nozzle decreases.

It has been found that useful distances from the nozzle N to the collection screen 46 may be from about 2 cm or more to about 500 cm or less, in some embodiments. In other embodiments, this distance is from 10 cm or more to about 180 cm or less. In one embodiment the collection screen 47 is 1.8 meters from the nozzle N.

It should also be understood that the performance of this process, especially the ability to form stable and continuous jets of spinnable fluid, is dictated by the fluid's properties, such as concentration (C), viscosity (p), and surface tension (γ), as in the electrospinning process. The mean diameter of the fibers is known to decrease with a reduction of viscosity or reduction of concentration of the spinnable material in the fluid.

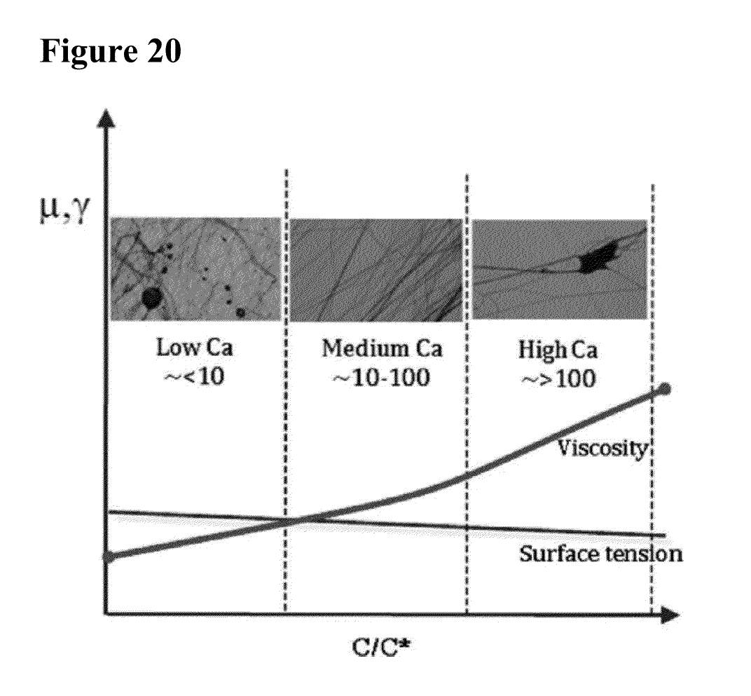

It is believed that the lower limit of spinnable material concentration is dictated by the critical concentration C* for achieving polymer chain entanglement. In this context, the capillary number (Ca) of the extended liquid jet relates the viscous stress with the interfacial stress, Ca=μV/γ, where and γ are the values of viscosity, velocity of the liquid jet, and surface tension of the spinnable solution, respectively. For systems with a low capillary number, for example, the surface tension dominated, the jets underwent early break-up due to Rayleigh instability and often lead to beaded fibers. Smooth fibers are produced at moderate values of Ca, achieved by increasing the spinnable fluid viscosity or the velocity of the liquid jet. At very high values of Ca, the fibers show defects induced by the turbulent nature of the gas flow. These cases are schematically presented in FIG. 20.

Yet another aspect of the present invention is a novel type of spinnable fluid and related methods of producing multi-component fibers having unique morphologies including but not limited to single, stratified core and sheath, side by side, and interpenetrating structures. In this aspect of the invention, only one nozzle is required because the spinnable fluid comprises a mixture of one or more solvents, wherein each one of the materials (e.g. polymers) used is soluble in at least one of the solvents and where the solutions are used as feeding streams of spinnable fluid pumped into one of the fiber spinning apparatus discussed above or any other suitable apparatus. The polymers may be miscible, partially miscible, or immiscible with each other. While this aspect of the invention will be discussed in terms of polymers, it is in no way so limited and any of the spinnable materials discussed above may be used.

In its essence, this approach exploits solvents with different vapor pressures and solubility parameters to attain controlled solvent evaporation rates and desired levels of phase separation of polymers. Homogeneous and temporarily stable solutions of immiscible polymers may be prepared by using miscible solvent pairs containing at least one solvent in the same solvent pair that is a good solvent for each of the component polymers. More simply put, polymer A is dissolved in solvent A, polymer B is dissolved in solvent B, and solvents A and B are miseible. The final fiber morphology from such precursor solutions is set when the viscosity of the compound increases to a level that further morphology change does not occur. The process creates structures with the polymer chains are fully mixed together in an ideal interpenetrating network, phase separated on a scale smaller than 10 nm, or as having undergone different degrees of separation to create interpenetrating, side-by-side, and/or core-shell morphological forms.

The solvents must be carefully selected to meet the following criteria. First-, all of the solvents used must be miscible with each other. There is no restriction on the number of solvents or the proportions of solvents that can be used as long as the solvents are miscible. One of skill in the art will be able to determine whether and under what conditions the solvents are miscible. In some embodiments, the ratio of the weight of the first solvent to the weight of the second solvent in the spinnable fluid is about 1 to 1.

Second, at least one of the solvents must be a good solvent for each one of the polymers used. As would be understood by those of skill in the art, a “good solvent” for a polymer refers to a solvent that readily dissolves a polymer and, conversely, a polymer that dissolves easily in a particular solvent is said to have an “affinity” for that solvent. The Hildebrand solubility parameters can be used to verify the polymer-solvent matching. Where the solubility parameters of a polymer and a solvent are very close to each other, they are said to be well matched and the polymer will easily dissolve in the solvent. It should be appreciated that the closeness of these two solubility parameters can be expressed as the square of the difference between these two solubility parameters. The smaller the square difference, the better the solvent is for the polymer.

By way of example, the solubility parameters for polyvinyl pyrrolidone, polyvinyl acetate and four typical solvents are set forth on Table 1 below. The solubility parameter values reported for methanol, isopropanol, ethyl acetate, and 1-butanol are 29.36, 23.51, 18.56, and 23.16 (MPa)¹¹² respectively and the solubility parameter values reported for polyvinyl pyrrolidone and polyvinyl acetate 25 and 19.2 (MPa)′ respectively. The square of the difference between the solubility parameters for polyvinyl acetate and ethyl acetate (19.2-18.56)² is 0.4 MPa, from which it can be concluded that ethyl acetate is a good solvent for polyvinyl acetate. On the other hand, the square of the difference between the solubility parameters for polyvinyl acetate and methanol (19.2-29.63)² is 108 MPa, from which it can be concluded that ethyl acetate is a poor solvent for polyvinyl acetate.

TABLE 1
Vapor pressure ratio Pₛ/P_{sw} of different solvents and affinity (δ_{P}-δₛ)² of PVP
and PVAc to different solvents. Subscript P in δ_{P} represents PVAc and PVP. Pₛ and P_{sw} are
at 20° C. δ_{P} and δₛ are solubility parameters of the polymer and the solvent respectively.

| | Vapor | Vapor | Solubility | Affinity of | Affinity of |
|---|---|---|---|---|---|
| | pressure; | pressure | parameter; | PVP (δ_{PVP}- | PVAc (δ_{PVAc}- |
| Component | KPa | ratio Pₛ/P_{sw} | (MPa)^{1/2} | δₛ)²; (MPa) | δₛ)²; (MPa) |
| methanol | 12.97 | 5.59 | 29.63 | 21.4 | 108 |
| isopropanol | 4.23 | 1.82 | 23.51 | 2.22 | 18.5 |
| ethylacetate | 9.85 | 4.24 | 18.56 | 41.4 | 0.4 |
| 1-butanol | 0.63 | 0.27 | 23.16 | 3.4 | 15.6 |
| PVP | | — | 25 | — | — |
| PVAc | — | — | 19.2 | — | — |

As used herein, a “good solvent” for a polymer is one where the range of the square of the difference between the solubility parameters for the polymer and the solvent is between 0.001 to 10 MPa, and preferably between 0.001 MPa to 5 MPa. Put another way, a polymer can be said to have an “affinity” for a particular solvent where square of the difference between the solubility parameters for the polymer and the solvent is between 0.001 to 10 MPa, and preferably between 0.001 to 5 MPa. In some embodiments, the first spinnable material has an affinity for the first solvent of from about 0.001 MPa to about 10 MPa, and is preferably between about 0.001 MPa to about 5 MPa and an affinity for the second solvent of from about 10 MPa to about 45 MPa. In some embodiments, the second spinnable material has an affinity for the second solvent of from about 0.001 MPa and about 5 MPa and an affinity for the first solvent of from about 10 MPa to about 45 MPa.

Third, the polymeric solution formed must be stable against coagulation, precipitation, stratification, and phase separation long enough to form the fibers. Generally, solutions prepared using this technique are stable for hours, which is more than enough for the purpose of forming fibers using this process.

In operation, a single continuous liquid jet is formed from the spinnable fluid using any one of the different nozzle types taught herein. The liquid jet undergoes continuous stretching and thinning with simultaneous evaporation of the solvent until the viscosity reaches a high value and further stretching stops and the morphology of the fiber is considered “frozen” and the polymer chain movement is restricted. The morphology of the fibers will largely be dictated by the kinetics of phase separation as the various solvents evaporate.

The precursor spinnable fluid, constructed as set forth above, is at least temporarily stable. If the two polymers are present at 50:50 ratio in the precursor solution and the evaporation rates of the two solvents are close, then in the solution in the fluid jet will remain stable long enough for the fiber to form before phase separation occurs. In this case, an interpenetrating morphology is expected. (See FIG. 7A). In general, the fiber morphology presented in fibers formed from these polymeric solutions will be controlled by those things that affect the phase separation of the polymers including, the solvent evaporation rates, the concentration of the polymers in their respective solvents, diffusivity of the solvent in the solid polymers, and the solubility parameter between the polymer and solvents used along with factors such as interfacial tension between the polymers, surface tension of the polymer solution, and shear and elongation viscosities of the polymer solution.

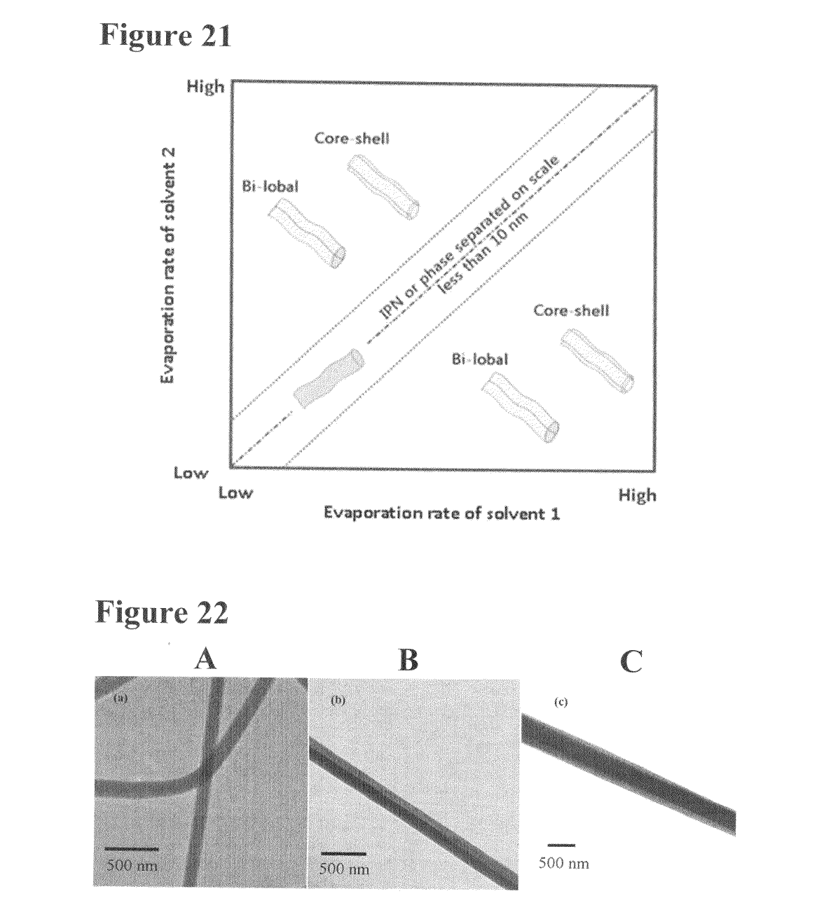

As is evident, the solvent evaporation rate plays a very large role in determining the morphology of the fibers produced by this method. A comparison of the vapor pressure of the solvent (Pₛ) at 20° C. to that of water (P_{sw}) at 20° C. may be used obtain an estimate of how fast the solvent will evaporate. By way of example, Table 1 presents the values of ratio of Pₛ and P_{sw} for methanol, isopropanol, 1-butanol, and ethylacetate. It is seen that evaporation rates of methanol and ethylacetate are close. In view of this, the ratio of the two solvents in the fiber at any time after the liquid jet emerges from the nozzle should remain close to the ratio in the precursor solution with adjustment from differences in molecular diffusion of the solvent molecules. In some embodiments, the ratio of the vapor pressure of the first solvent at 20 degrees Centigrade to the vapor pressure of water at 20 degrees Centigrade is from about 0.01 to about 50.00 and more preferably is from about 0.01 to about 20.00. In some embodiments, the ratio of the vapor pressure of the second solvent at 20 degrees Centigrade to the vapor pressure of water at 20 degrees Centigrade is from about 0.01 to about 50.00 and more preferably is from about 0.01 to about 20.00. FIG. 21 presents schematically a summary of the above discussion and lists expected fiber morphologies obtained with two immiscible polymers dissolved in precursor solutions of a miscible pair of solvents based upon the evaporation rates of the solvents.

As set forth above, if a two-component blend of polymers is used and the solvents have equal solvent evaporation rate, fibers with interpenetrating structures are more likely to be obtained. In some embodiments, the predetermined morphology is an interpenetrating morphology and the ratio of the solvent evaporation rate for the first solvent to the solvent evaporation rate of the second solvent is from about 0.8:1 to about 1:1 weight and more preferably is from about 0.9:1 to about 1:1.

Likewise, it has been found that if a two-component blend of polymer is used and one of the solvents present has a higher solvent evaporation rate than the other and the difference in solvent evaporation rate is significant (e.g. by at least a factor of 2), polymer phase separation occurs due to more volatile solvent evaporation and a side by side morphology is obtained. In some embodiments, the predetermined morphology is a side by side morphology and the ratio of the solvent evaporation rate for the first solvent to the solvent evaporation rate of the second solvent is from about 5:1 to about 2.5:1 and more preferably is from about 3:1 to about 2.5:1. Further, it has been found that, if a two-component blend of polymers is used and one of the solvents evaporates at about a 10 times faster rate, the fibers obtained will have a core-shell morphology. In some embodiments, the predetermined morphology is a core and sheath morphology and the ratio of the solvent evaporation rate for the first solvent to the solvent evaporation rate of the second solvent is from about 20:1 to about 10:1 weight and more preferably is from about 15:1 to about 10:1. These three cases are schematically represented in FIGS. 7A, 7B and 7C

However, the relative volume fractions of the polymers in the precursor solution are also reflected in the fibers. In some embodiments, the ratio of the weight of the first spinnable material to the weight of the second spinnable material in the spinnable fluid is from about 1 to 1 to about 2 to 1. For example, if fibers are being produced with side-by-side morphologies by using differences in solvent evaporation rates of approximately 2:10, you can use the polymers in different ratios, e.g., twice as much polymer A than polymer B. In this case the fiber will have the side by side morphology but 66% will be from polymer A and only a small fraction (33%) will be polymer B.

It has also been found that the diameter of the initial fluid jet, which is largely a function of the viscosity of the spinnable fluid and the velocity of the gas jet, also has an effect on the morphology of the fibers. The smaller the diameter of the initial fluid jet, the faster the solvents can evaporate and the more likely the fiber will form before phase separation occurs. The molecules of the solvent must diffuse through the polymer to reach the polymer-air interface where solvent evaporation takes place. The larger the diameter of the initial fluid jet, the further the solvent must travel to reach to the polymer-air interface where solvent evaporation takes place. The larger the diameter of the initial fluid jet, the more the diffusivity of the polymer becomes important to fiber formation.

The viscosity of the precursor solution is a function of the proportion of spinnable material in the solutions, which itself may depend, at least in part, on the relative solubility parameters of the solvents and polymers. In some embodiments, the proportion of the plurality of components for forming fibers in the spinnable fluid is from about 1 percent to about 90 percent by weight and more preferably is from about 3 percent to about 70 percent by weight. In some embodiments, the proportion of the plurality of components for forming fibers in the spinnable fluid is from about 1 percent by weight to about 30 percent by weight and more preferably is from about 3 percent by weight to about 15 percent by weight.

This invention is not limited to the production of fibers with these three morphologies or with only two component polymers. For example, multicomponent fibers with stratified or coaxial morphologies can be obtained by a blend of more than two components in compatible solvents, and each of the fluids may contain dissolved substances, colloids, small crystals, fluid droplets or other particles, which are sequestered in the fiber and thereby available to perform useful functions in systems that incorporate the thin, multi-component fibers. The temperature of the fluids and the evaporation rate of the solvents are other process parameters that may be varied to control the production of multi-component fibers.

The invention provides important new options for the economical production of multi-component fibers with a wide range of morphologies, including, core-shell fibers of more than two polymers, side by side fibers, mixtures of single, side by side, and coaxial fibers, and multiple parallel (islands in the sea) fibers. This invention is also novel in the way that it enables two or more polymeric components to be combined in composite fibers with a wide variety of morphologies that can be prepared to serve specific useful purposes such as drug delivery from a suture, mechanical properties that vary with the gradual removal or change in one or more of the composite materials, and the like.

Several products may benefit from this invention. These include filters used in automobiles for cleaning of air and liquid fuels, filters used in air handling systems in buildings and hospitals, apparels, tissue scaffolds, and chemical sensors.

The multi-component fiber having an interpenetrating morphology as depicted in FIGS. 7A and 22A and may be used in production of antibacterial apparels. Fibers having inter-penetrating morphologies of polyvinyl acetate and polyvinyl pyrrolidone have been produced. Such fibers are not wetted by water or hydrocarbon liquids. Also, such fibers may not allow growth of bacteria as the hydrophilic polymer is not continuous and present an attractive means to fabricate apparels other textile items for use by soldiers in swamplands and bacteria-infested war fields.

The polymer fibers of unique morphology depicted in FIGS. 7B and 22B has been produced from hydrophobic/hydrophilic polymer combinations—polyvinyl acetate and polyvinyl pyrrolidone respectively and as shown in FIG. 22. Such fibers can remove both water and oil droplets and particulate solids of different charges from air. In another embodiment, one of the polymer components in fiber depicted in FIG. 7B can be ‘tuned’ chemically to capture heavy metals and arsenic from aqueous streams, while the second polymer component provides structural integrity and offers mechanical strength. The polymer fiber depicted in FIGS. 7C and 22C can be used as ion conductors, capacitors, and electrically conductive materials.

As set forth above, this invention is by no means restricted to the production of fibers with the previously described morphologies. For example, multi-component polymers with stratified morphologies, made with a mixture of two or more solvents and where the solution may contain dissolved substances, colloids, small crystals, fluid droplets or other particles, which are sequestered in the fiber can be used. Moreover, while the fiber making apparatus 10 is generally described herein in terms of forming a single fiber, this invention in no way so limited and also contemplates the use of an array of nozzles and gas jets to produce multiple fibers at the same time. See FIGS. 23, 24, and 25 discussed above.

### EXAMPLES

The following examples are offered to more fully illustrate the invention, but are not to be construed as limiting the scope thereof. Further, while some of examples may include conclusions about the way the invention may function, the inventor do not intend to be bound by those conclusions, but put them forth only as possible explanations. Moreover, unless noted by use of past tense, presentation of an example does not imply that an experiment or procedure was, or was not, conducted, or that results were, or were not actually obtained. Efforts have been made to ensure accuracy with respect to numbers used (e.g., amounts, temperature), but some experimental errors and deviations may be present. Unless indicated otherwise, parts are parts by weight, molecular weight is weight average molecular weight, temperature is in degrees Centigrade, and pressure is at or near atmospheric.

### Example 1

### Production of Polyethylene Oxide Fibers Using a Needle-Tip Nozzle

A solution of polyethylene oxide in ethanol was used to form nanofibers from a needle-tip nozzle. First, 50 mL of ethanol of 99% wt purity was poured into a 100 mL erlenmeyer flask provided with a stopper to avoid solvent evaporation. Then, 5 grams of polyethylene oxide (Mw=300,000 g/mol, Alfa Aesar) were weighed and added slowly into the ethanol solvent during a period of time of around 2 minutes. The solution was mixed by using a magnetic stirred at 40° C. during 24 hours until all the polyethylene oxide was dissolved. After this, the white colored viscous solution was kept at room temperature for at least 6 hours before using it.

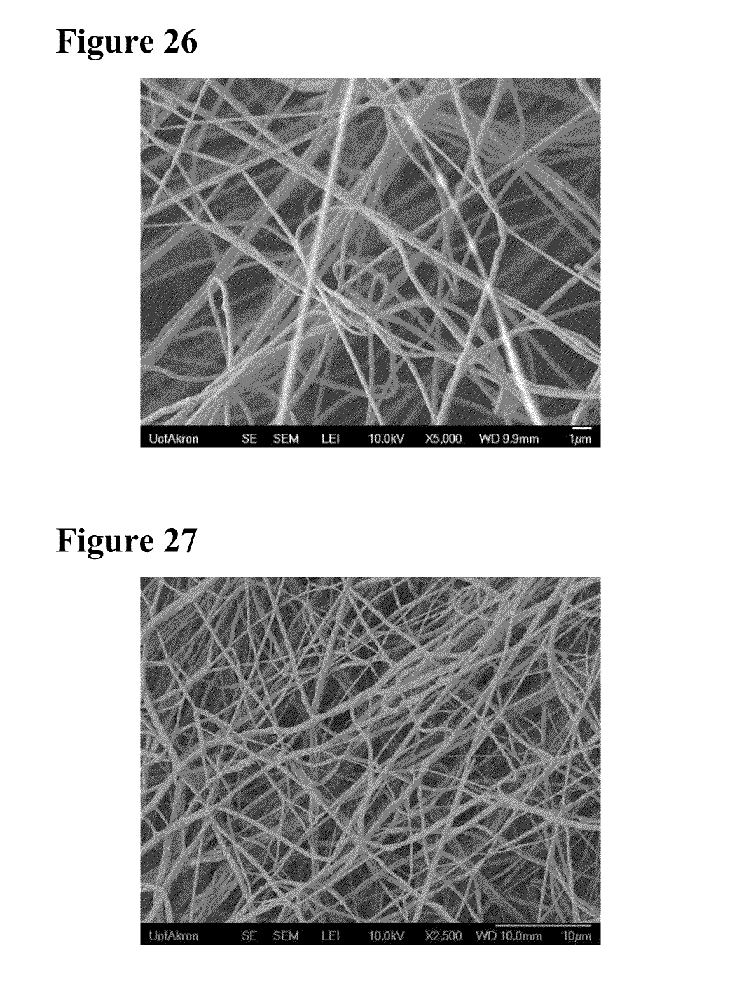

After 6 hours, the solution of polyethylene oxide was poured in a 50 mL syringe coupled with a non-sharp stainless steel needle (internal tubing diameter Ø=1.219 mm). A syringe pump (Fusion 1000, Chemyx Inc.) was used to feed the polymer solution at a constant rate of 0.4 mL/min. An industrial line of compressed air connected to a pressure regulator and a flow meter was attached to a plastic non-deformable circular cross sectional area tubing (internal diameter Ø=11 mm) to form the gas jet. A pressure of 20 psi (volumetric flow of 12 SCFM) was directed perpendicular to the needle with the polymer solution and kept at a distance of 2 cm. The polymer jet formed traveled 1.8 meters to a fiberglass mat screen used to collect the fiber. The process was run continuously for 10 minutes until a substantial amount of fiber was collected. The weight gain of the fiberglass mat screen representing the weight of the nanofibers produced was recorded to be 0.387 grams. A sample of the nanofiber formed was taken and analyzed by using a JSM-7401F JEOL scanning electron microscope (SEM). FIG. 26 shows an SEM photograph of the fiber produced. The mean diameter was 610 nm.

### Example 2

### Production of Polyethylene Oxide Nanofibers Using a Wall-Anchored Nozzle

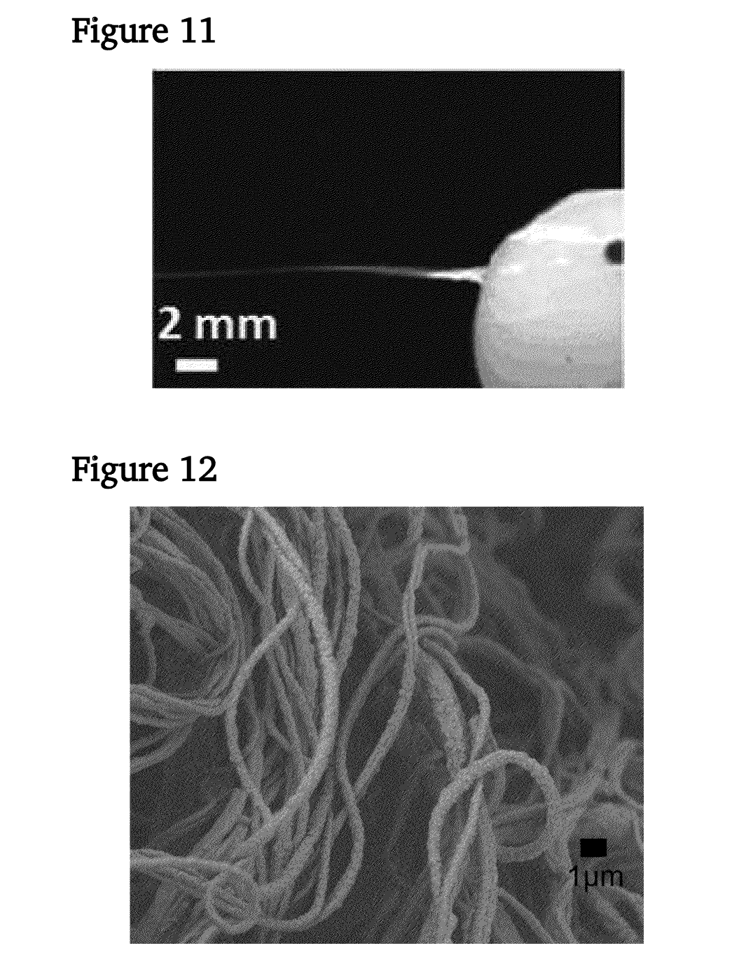

The solution from the Example 1 was used to produce nanofibers from a wall-anchored nozzle. First a 50 mL syringe filled with the polyethylene oxide solution from example 1 was coupled with a wall-anchored nozzle. The wall-anchored nozzle was built by attaching a non-sharp needle tubing into a round shape piece of plastic made of polypropylene (20 mm diameter×2 mm thickness). (See e.g. FIG. 11) The needle was inserted at a distance of two millimeter away from the round border leaving 18 mm of vertical free path for the polymeric solution to flow.

A syringe pump (Fusion 1000, Chemyx Inc.) was used to feed the polymer solution at a constant rate of 0.4 mL/min. An industrial line of air compressed connected to a pressure regulator and a flow meter was attached to a plastic non-deformable circular cross sectional area tubing (internal diameter Ø=11 mm) to form the gas jet. A pressure of 20 psi (Volumetric flow of 12 SCFM) was directed perpendicular to the wall-anchored nozzle with the polymer solution and kept at a distance of 2 cm. The polymer jet formed traveled 1.8 meters to a fiber glass mat screen used to collect the fiber. The process was run continuously for 10 minutes until a substantial amount of fiber was collected. The gain weight of the screen was recorded to be 0.367 grams. A sample of the nanofiber formed was taken and analyzed by using a JSM-7401F JEOL scanning electron microscope (SEM). FIG. 27 shows an SEM photograph of the fiber produced. Mean diameter was calculated to be 575 nm.

### Example 3

### Production of Polyvinyl Pyrrolidone Nanofiber from a Needle-Tip Nozzle

A solution of polyvinyl pyrrolidone in ethanol was used to form nanofibers from a needle-tip nozzle. First, 50 mL of ethanol (99% weight purity) were poured into a 100 mL erlenmeyer flask including a stopper to avoid solvent evaporation. Then, 5 grams of polyvinyl pyrrolidone (Mw=1,300,000 g/mol Alfa Aesar) were weighed and added slowly into the ethanol solvent during a period of time of around 2 minutes. The solution was mixed by using a magnetic stirrer at 40° C. for 24 hours until all the polyvinyl pyrrolidone was dissolved. After this, the clear viscous solution was kept at room temperature for at least 6 hours before use.

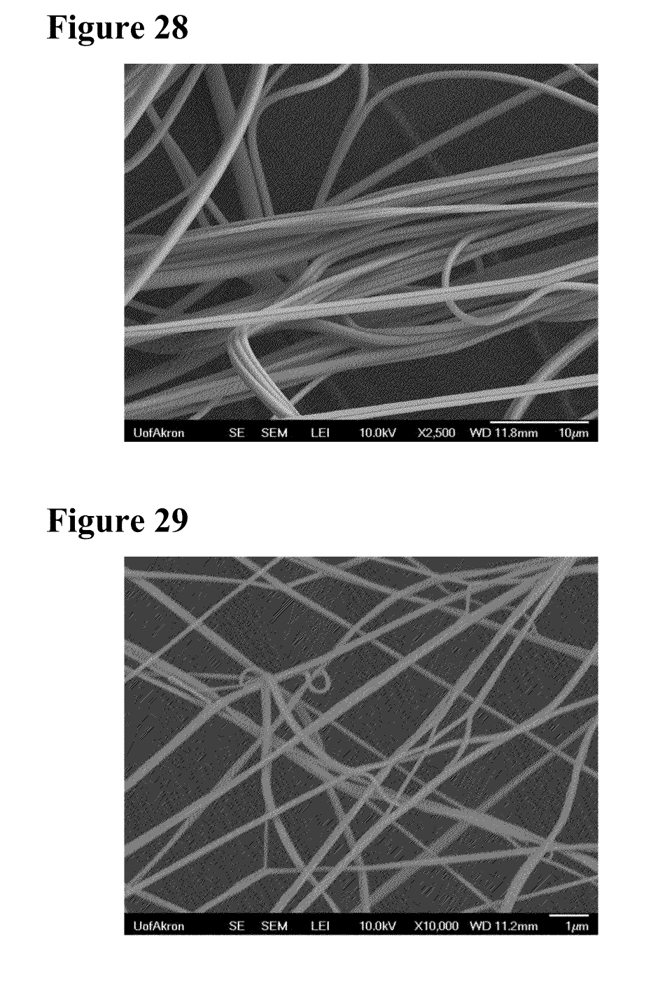

After 6 hours, the solution of polyvinyl pyrrolidone was poured in a 50 mL syringe coupled with a non-sharp stainless steel needle (internal tubing diameter Ø=0.835 mm). A syringe pump (Fusion 1000, Chemyx Inc.) was used to feed the polymer solution at a constant rate of 0.8 mL/min. An industrial compressed line of air including a pressure regulator and a flow meter was attached to a plastic non-deformable circular cross sectional area tubing (internal diameter Ø=6 mm) to form the gas jet. A pressure of 40 Psi (Volumetric flow of 10 SCFM) was directed perpendicular to the needle with the polymer solution and kept at a distance of 2 cm. The polymer jet formed traveled 1.8 meters to a fiber glass mat screen used to collect the fiber. The process was run continuously for 10 minutes until a substantial amount of fiber was collected. The gain weight of the screen was recorded to be 0.39 grams. A sample of the nanofiber formed was taken and analyzed by using a JSM-7401F JEOL scanning electron microscope (SEM). FIG. 28 shows an SEM photograph of the fiber produced. Mean diameter was calculated to be 469 nm.

### Example 4

### Production of Polyvinyl Pyrrolidone Nanofiber from a Pendant-Drop Nozzle

The solution from example 3 was used to produce nanofibers from a pendant-drop nozzle. First, a capillary tube (3 mL internal capacity and diameter Ø=2.1 mm) was filled with the polyvinyl pyrrolidone solution from example 3. A syringe pump (Fusion 1000, Chemyx Inc.) was connected to the top of the capillary tube and used to feed the polymer solution at a constant rate of 0.06 mL/min. The capillary tube was positioned vertically in such a way that a constant dripping regime of the polymer solution was reached. An industrial line of compressed air including a pressure regulator and a flow meter was attached to a plastic non-deformable circular cross sectional area tubing (internal diameter Ø=11 mm) to form the gas jet. A pressure of 5 psi (volumetric flow of 1.2 SCFM) was directed perpendicular to the formed drops of polymer and kept at a distance of 2 cm. A polymer jet was formed and the fiber formed traveled 40 cm to a fiberglass mat screen used to collect the fiber. The process was run continuously for 10 minutes until a substantial amount of fiber was collected. The gain weight of the screen was recorded to be 0.045 grams. A sample of the nanofiber formed was taken and analyzed by using a JSM-7401F JEOL scanning electron microscope (SEM). FIG. 29 shows an SEM photograph of the fiber produced. Mean diameter was calculated to be 120 nm.

### Example 5

### Production of Fibers with Core-Shell Structures from a Needle-Point Nozzle

Solutions of polyethylene oxide in ethanol and polyvinyl pyrrolidone in ethanol were used to produce nanofibers with core-shell morphology from a needle-tip nozzle. First, solutions of polyethylene oxide 10% wt in ethanol and polyvinyl pyrrolidone 10% wt in ethanol were prepared. For the polyethylene oxide solution, 50 mL of ethanol (99% wt purity) was poured into a 100 mL erlenmeyer flask provided with a stopper to avoid solvent evaporation. Then, 5 grams of polyethylene oxide (Mw=300,000 g/mol Alfa Aesar) were weighed and added slowly into the ethanol solvent during a period of time of around 2 minutes. The solution was mixed by using a magnetic stirrer at 40° C. for 24 hours until all the polyethylene oxide was dissolved. After this, the white colored viscous solution was kept at room temperature for at least 6 hours before use. For the polyvinyl pyrrolidone solution, 50 mL of ethanol (99% wt purity) were poured into a 100 mL erlenmeyer flask provided with a stopper to avoid solvent evaporation. Then, 5 grams of polyvinyl pyrrolidone (Mw=1,300,000 g/mol Alfa Aesar) were weighed and added slowly into the ethanol during a period of time of around 2 minutes. The solution was mixed using a magnetic stirrer at 40° C. during 24 hours until all the polyvinyl pyrrolidone was dissolved. After this, the clear viscous solution was kept at room temperature for at least 6 hours before use.

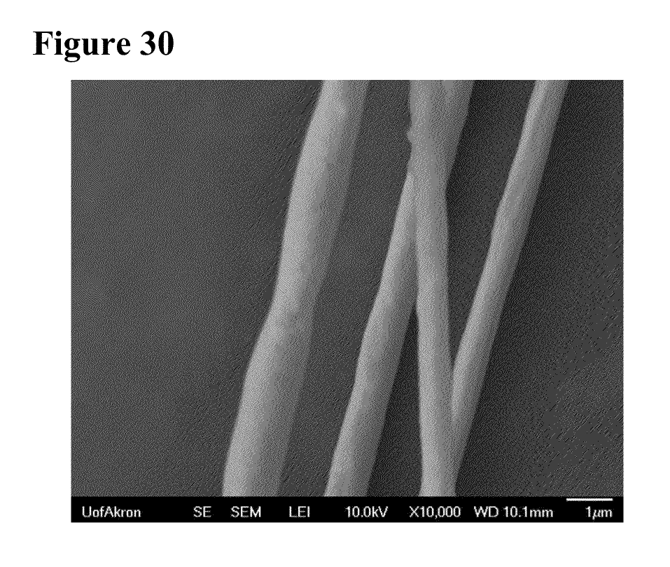

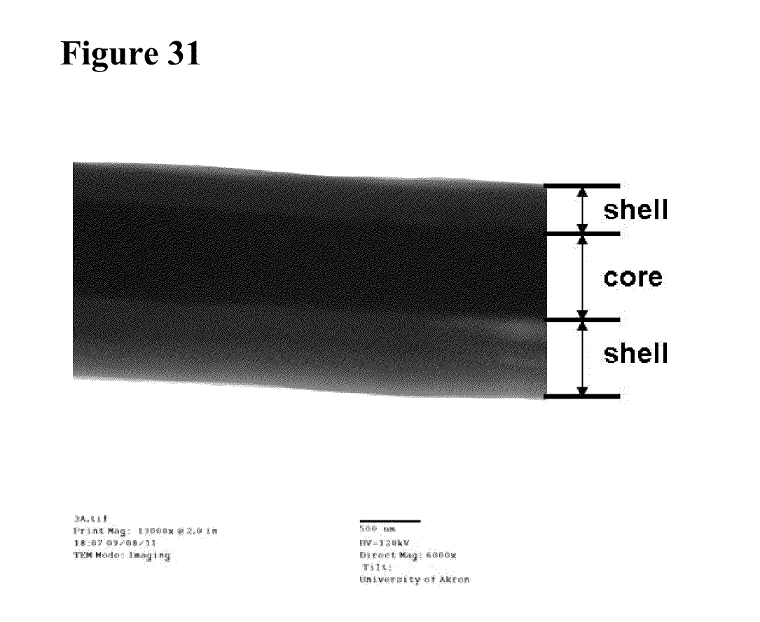

The solutions were used to produce nanofibers with core-shell morphology by using a coaxial needle-point nozzle. The coaxial needle-point nozzle was built by creating a coaxial flow of the two polymer solutions before entering the non-sharp needle-tip nozzle. To do this, a 90° bent needle (internal diameter Ø=0.406 mm) was introduced into the body of a plastic syringe (internal diameter Ø=10 mm) in such a way that coaxial paths were formed by the fluid coming from the syringe and the fluid coming from the bent needle. The coaxial set-up built was connected to a non-sharp needle tubing as nozzle. Then, a 50 mL syringe connected to the syringe of 10 mm diameter was filled with the shell polymer solution (polyethylene oxide). Additionally, a 20 mL syringe was filled with the core polymer solution (polyvinyl pyrrolidone) and connected to the coaxial needle. Two syringe pumps (Fusion 1000, Chemyx Inc.) were used to feed the polymer solutions at a constant rate of 0.4 mL/min each one. A compressed industrial line of air including a pressure regulator and a flow meter was attached to a plastic non-deformable circular cross sectional area tubing (internal diameter Ø=12 mm) to form the gas jet. A pressure of 20 psi (volumetric flow of 12 SCFM) was directed perpendicular to the needle with the polymer solutions and kept at a distance of 2 cm. The polymer jet formed traveled 1.8 meters to a fiber glass mat screen used to collect the fiber. The process was run continuously for 10 minutes until a substantial amount of fiber was collected. The gain weight of the screen was recorded to be 0.71 gr. A sample of the nanofiber formed was taken and analyzed by using a JSM-7401F JEOL scanning electron microscope (SEM) and a transmission electron microscopes (TEM), JEOL 1230. FIG. 30 shows a SEM photograph of the fiber produced. Mean diameter was calculated to be 1030 nm. FIG. 31, shows a TEM photograph of the fiber produced. The core-shell structure of the fiber can be identified.

### Example 6

### Production of Fibers with Side-by-Side Structures from a Wall-Anchored Nozzle

Solutions of polyethylene oxide in ethanol (polymer solution 1) and polyvinyl acetate in ethyl acetate (polymer solution 2) were used to produce nanofibers with side-by-side morphology from a wall-anchored nozzle. First, solutions of polyethylene oxide 10% wt in ethanol and polyvinyl acetate 10% wt in ethyl acetate were prepared. For the polyethylene oxide solution, 50 mL of ethanol 99% wt purity were poured into a 100 mL erlenmeyer flask provided with a stopper to avoid solvent evaporation. Then, 5 grams of polyethylene oxide (Mw=300,000 g/mol Alfa Aesar) was weighed and added slowly into the ethanol solvent during a period of time of around 2 minutes. The solution was mixed by using a magnetic stirrer at 40° C. during 24 hours until all the polyethylene oxide was dissolved. After this, the white colored viscous solution was kept at room temperature for at least 6 hours before using it. For the polyvinyl acetate solution, 50 mL of ethyl acetate 99% wt purity were poured into a 100 mL erlenmeyer flask provided with a stopper to avoid solvent evaporation. Then, 5 grams of polyvinyl acetate (Mw=500,000 g/mol Alfa Aesar) were weighed and added slowly into the ethyl acetate during a period of time of around 2 minutes. The solution was mixed by using a magnetic stirred at 40° C. during 24 hours until all the polyvinyl acetate was dissolved. After this, the clear viscous solution was kept at room temperature for at least 6 hours before use.

The solutions previously prepared were used to produce nanofibers with side-by-side morphologies from an adapted wall-anchored nozzle. The nozzle to produce fibers with side-by-side morphology was built to create a stratified flow of the two polymer solution fluids before the fiber was formed. To do this a wall-anchored nozzle with two inlets with a 4 mm separation for the two solutions, composing the side-by-side fiber was created by adapting two different inlets at different heights on a flat rectangular plastic piece of 20 mm×50 mm and 2 mm of thickness. The polymer solution 1 was allowed to flow at a higher position and flowed by gravity action to the inlet of the polymer solution 2. The resulting two layer solution continued flowing by gravity action until the jet of gas was directed to the fluid and a single polymer jet containing both components was created. Two syringe pumps (Fusion 1000, Chemyx Inc.) were used to feed the polymer solutions at a constant rate of 0.4 mL/min each one. A compressed industrial line of air including a pressure regulator and a flow meter was attached to a plastic non-deformable circular cross sectional area tubing (internal diameter Ø=12 mm) to form the gas jet. A pressure of 20 Psi (volumetric flow of 12 SCFM) was directed perpendicular to the wall-anchored nozzle with the polymer solutions and kept at a distance of 2 cm. The polymer jet formed traveled 1.8 meters to a fiber glass mat screen used to collect the fiber. The process was run continuously for 10 minutes until a substantial amount of fiber was collected. The gain weight of the screen was recorded to be 0.647 gr. A sample of the nanofiber formed was taken and analyzed by using a JSM-7401F JEOL scanning electron microscope (SEM). FIG. 8 shows an SEM photograph of the fiber produced. Mean diameter was calculated to be 1650 nm.

### Example 7

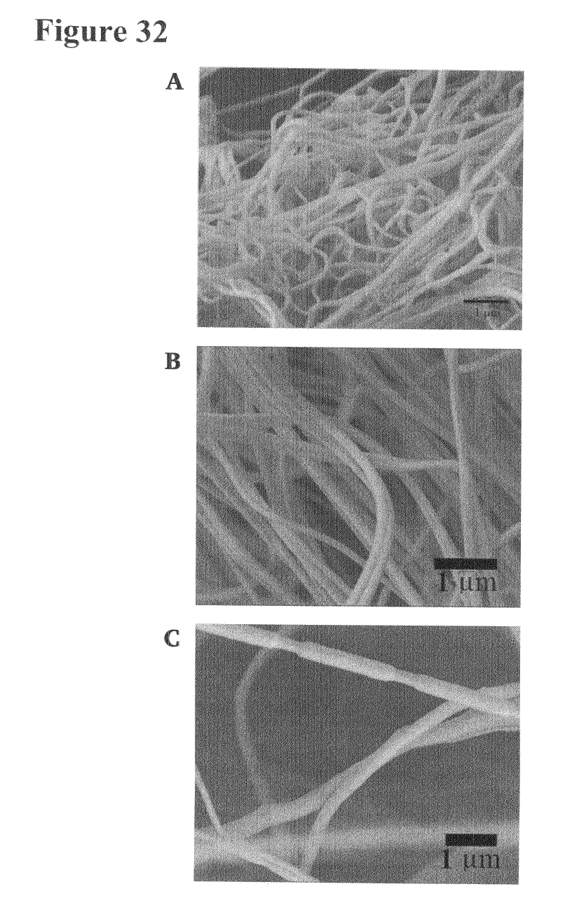

The capability and feasibility of the process was demonstrated by producing fibers from 6% w/w solution of polyethylene oxide (PEO, Mw=300,000 g/g mol from Alfa Aesar) in ethanol, 6% w/w solution of polyvinyl pyrrolidone (PVP, Mw=1,300,000 g/g mol from Alfa Aesar) in ethanol, and 6% w/w solution of polyvinyl acetate (PVAc, Mw=500,000 g/g mol, from Sigma Aldrich) in ethyl acetate, using several nozzles built in-house. Needle-tip nozzles were built from stainless steel needles of internal diameter 0.3-1.22 mm. Wall-anchored nozzle assembly (FIGS. 1-3) was built by attaching 1 mL syringes to flat plastic plates. Glass capillary tubes of 1 mm diameter were used to create pendant drops. (see FIG. 9) The high velocity air jet was created by allowing compressed air to flow through a rigid pipe of internal diameter 11 mm, fitted with a filter, pressure regulator, and a flow meter. The scanning electron microscope (SEM) images of the mats of fibers prepared from the above solutions using a needle-tip nozzle (FIG. 10) of 1.2 mm of internal diameter are presented in FIG. 32 A-C. Fibers with mean diameter of, respectively, 280, 186, and 425 nm were obtained for PEO, PVP, and PVAc using compressed air jet with 40 psi pressure and solution feeding rate of 0.8 mL/min.

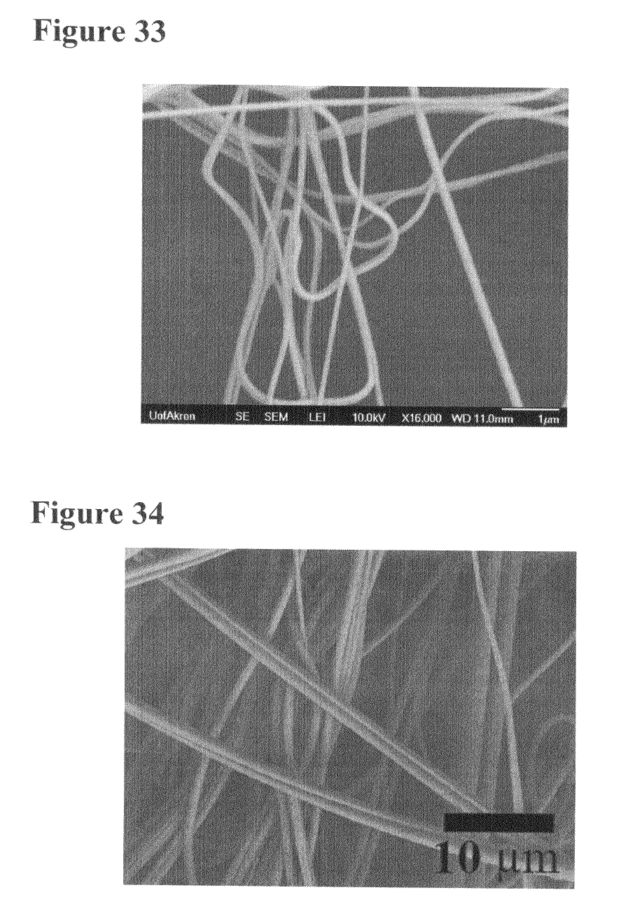

In these experiments, the effects of processing variables such as the air jet pressure, distance between the nozzles for polymer solution and the air jet, volumetric rate of polymer solution, and the distance from the nozzle where the polymer fibers are collected the fiber mean diameter and morphology were studied. FIG. 19 presents SEM images of PVP nanofibers obtained from 10% w/w solution in ethanol using the needle-tip nozzle at a feeding rate of 0.8 mL/min and different air jet pressures. As is evident, an increase of the air jet pressure from 10 to 30 psi caused a reduction of the number average mean diameter of the fibers from 1.6 to 0.34 μm. The same nozzle allowed an increase of the volumetric flow rate of solution to 1.6 mL/min without significant changes in the fiber diameter. A further increase of solution flow rate resulted in the formation of solid beads along the fiber. Fibers of a few tens of nanometer were produced using a low concentration of polymers in solution; a 2% w/w PVP solution in ethanol led to fibers of 60 nm mean diameter (FIG. 33) The PEO fibers obtained showed a diameter comparable to electrospinning.

Table 2 presents a summary of the effects of several processing variables on fiber diameter and morphology. It is seen that there is no significant difference between the fibers produced using a wall-anchored nozzle (FIG. 3) or a needle-tip nozzle (FIG. 10) if process parameters are similar. On the other hand, the nozzle configuration based on pendant drops (FIG. 9) gave rise to fibers with a much smaller mean diameter (˜200 nm) at low air jet pressures of 10 psi. At a higher pressure of the air jet the pendent drop became unstable.

TABLE 2
Effect of Processing Variables on Fiber Diameter and Morphology
Obtained by GJF Process^{a}

| | | air | | | | | |
|---|---|---|---|---|---|---|---|
| | | pressure | | mean | | | solid |
| polymer | | (psi); air | collect. | fiber | | | polymer |
| and mol | Conc. | flow rate | dist. | diameter | nozzle | fiber | feeding |
| wt | wt % | (m3/min) | (m) | (μm) | type | characteristics | rate (g/h) |
| PEO 1M | 3.5 | 10; 0.1556 | 1.8 | 3.6 | needle- | fiber | 1.7 |
| | | | | | tip | | |
| PEO 1M | 3.5 | 20; 0.1339 | 1.8 | 1.7 | needle- | fiber | 1.7 |
| | | | | | tip | | |
| PEO 1M | 3.5 | 30; 0.12 | 1.8 | 1.2 | needle- | fiber | 1.7 |
| | | | | | tip | | |
| PEO 1M | 3.5 | 40; 0.1081 | 1.8 | 0.8 | needle- | fiber | 1.7 |
| | | | | | tip | | |
| PEO 300K | 3 | 15; 0.1422 | 1.8 | 0.2 | wall- | fiber | 1.4 |
| | | | | | anchored | | |
| PEO 300K | 3 | 15; 0.1422 | 1.8 | 0.2 | needle- | fiber | 1.4 |
| | | | | | tip | | |
| PEO 1M | 3 | 10; 0.1556 | 1.8 | 0.2 | pendant | fiber | 0.09 |
| | | | | | drop | | |
| PVP 1.3M | 6 | 10; 0.1556 | 1.8 | 0.2 | wall- | fiber | 2.9 |
| | | | | | anchored | | |
| PVP 1.3M | 6 | 20; 0.1339 | 1.8 | 0.4 | wall- | fiber | 5.7 |
| | | | | | anchored | | |
| PVP 1.3M | 6 | 30; 0.12 | 1.8 | 0.6 | wall- | fiber and | 8.6 |
| | | | | | anchored | bead | |
| PVP 1.3 | 2 | 20; 0.1339 | 1.8 | 0.1 | wall- | fiber and | 0.9 |
| | | | | | anchored | bead | |

^{a}Polymer molecular weight 1M = 1,000,000; 300K = 300,000, 1.3M = 1,300,000. Needle-tip nozzle diameter Ø = 0.83 mm. Air flow rate is in cubic meter per min at 20° C. and at pressure indicated in the table.

### Example 8

In this experiment, fibers with side-by-side and core-shell morphological forms were produced using a wall-anchored nozzle system (FIG. 3) modified to include two polymer streams, as shown in FIG. 7A. In this case, polymer solution A is allowed to flow over polymer solution B forming a stratified two-layer falling liquid stream before an air jet turns the stream into a liquid jet. In this manner, fibers with side-by-side morphology of mean diameter 0.8 μm were obtained from a solution of PEO 6% w/w in ethanol and PVP 6% w/w in ethanol at a feed rate of 0.4 mL/min for each solution and air jet pressure of 20 psi (FIG. 34).

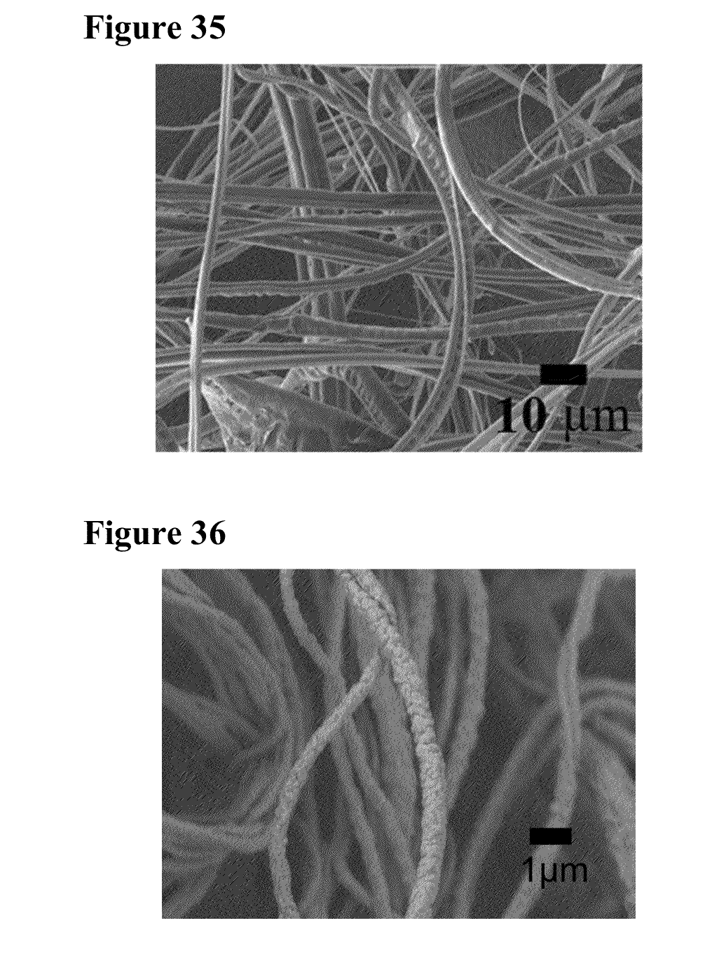

The same prototype nozzle was used to produce fibers from immiscible polymer systems, such as PVAc 6% w/w in ethyl acetate and PEO 6% w/w in ethanol, as shown in FIG. 35. The side-by-side, fused fibers of immiscible polymers PVAc and PEO seen in FIG. 35 demonstrate the possibilities of combining other immiscible polymers into nanofibers.

### Example 9

In this experiment, a set of immiscible and miscible polymers was converted into nanofibers having a core-shell morphology using the coaxial feeding arrangement (syringe-in-syringe technique) shown in FIG. 4. In addition, this process was used to incorporate nanoparticles into the nanofibers.

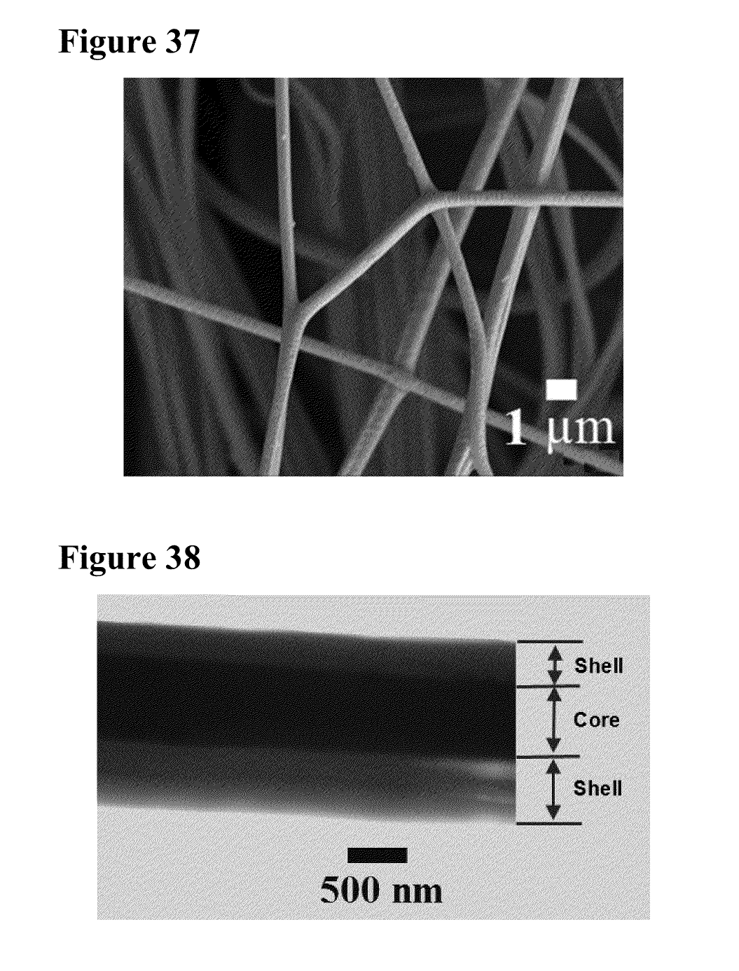

A solution of 6% w/w of PEO and trisilanol isobutyl polyhedral oligomeric silsesquioxane (POSS) particles (1:3 ratio) in ethanol was converted into fibers (FIG. 36). The self-assembly of POSS molecules in the polymer led to rough surface morphology of the fibers. Smooth fibers (FIG. 37) were obtained when the PEO/POSS solution was kept in the core and a solution of PVAc 6% w/w in ethyl acetate was kept as the shell with a feeding ratio of 1:2 w/w. FIG. 38 presents transmission electron microscope image of fibers with ˜620 nm diameter core of PVP and shell of PEO.

### Example 10

In these experiments, the feasibility of producing nanofibers from immiscible polymers polyvinylacetate (PVAc) and polyvinylpyrrolidone (PVP) using a single solvent mixture of the present invention. This blend was especially selected because of the contrasting hydrophilic and hydrophobic characters of PVP and PVAc respectively. These polymers were also selected because the differences in electron densities between PVP and PVAc allowed observation of individual polymer organization in the fiber strands by transmission electron microscopy (TEM).

PVP (Mw=1,300,000 g/gmol) was obtained from Alfa Aesar and PVAc (Mw=500,000 g/gmol), ethylacetate with density 0.902 g/mL at 25° C., 1-butanol with density 0.81 g/mL at 25° C., isopropanol with density 0.785 g/mL at 25° C., and methanol with density 0.791 g/mL at 25° C. all reagent grade or higher were purchased from Sigma Aldrich. These chemicals were used without further purification. The polymer solutions were prepared with total amount of polymers in the solution fixed at 3% by weight. The solvent ratio was kept at 1:1 wt/wt. Solutions of PVP/PVAc 1:1 wt/wt in methanol/ethylacetate, PVP/PVAc 1:1 wt/wt in isopropanol/ethylacetate, PVP/PVAc 2:1 wt/wt in isopropanol/ethylacetate and PVP/PVAc 1:1 wt/wt in 1-butanol/ethylacetate were prepared at room temperature by overnight stirring of the polymers in solvent mixtures using a magnetic stirring bar.

The experimental setup generally that of the needle-tip embodiment discussed above wherein a cylindrical pipe of 1.1 cm internal diameter was used for the gas jet and the inner diameter of the needle-tip nozzle was 0.83 mm. The solution feeding rate was maintained at 0.5 mL/min by using a controlled infusion syringe pump, as set forth above. Pressure of the gas jet was fixed at 20 psi (11 SCFM) for all the cases. The morphology of the samples was studied using scanning electron microscopy (SEM) and TEM. The presence of the two polymer components in the composite fibers was verified using differential scanning calorimeter.

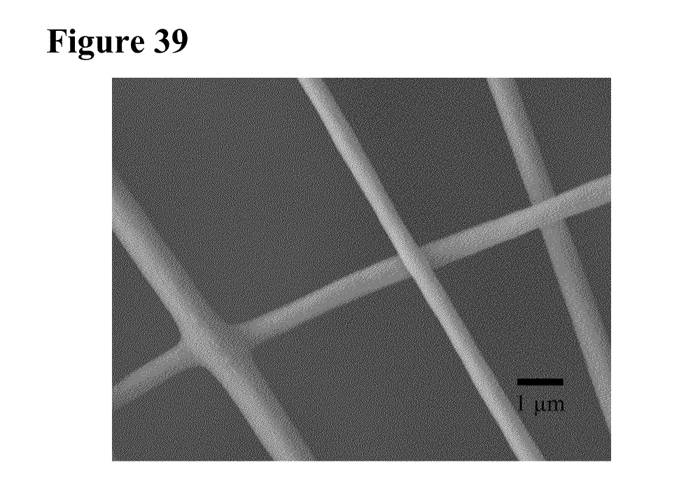

FIG. 39 is an SEM micrograph of nanofibers produced from solution of PVAc and PVP in isopropanol/ethylacetate mixed solvent. These nanofibers show diameters below 500 nm with smooth surfaces. Similar results were obtained for fibers of PVP/PVAc obtained from solutions in methanol/ethylacetate and 1-butanol/ethylacetate (not shown). FIG. 22A-C shows TEM images of fibers produced from solutions of PVP/PVAc 1:1 wt/wt in methanol/ethylacetate, isopropanol/ethylacetate, and 1-butanol/ethylacetate respectively. As shown in FIG. 22A, the nanofibers obtained from methanol/ethylacetate solution present uniform interpenetrating network (IPN) morphology with no easily identifiable polymer domains at the resolution of the TEM, below 10 nm. However, a side-by side morphology was produced when isopropanol replaced methanol as one of the solvents FIG. 22B. The differences in solvent evaporation rates and solubility parameters of the polymers can be invoked to interpret the differences in fiber morphology seen in FIG. 22.

It is believed that ethyl acetate evaporates faster due to higher vapor pressure when mixed solvents isopropanol and ethyl acetate are used in polymer solutions since the value of Pₛ/P_{sw} ratio for isopropanol and ethyl acetate is 1.82 and 4.24 respectively. It is believed that this triggers phase separation of PVAc due to differences in solubility parameters with isopropanol as reported in Table 2 above. Further, the square of the difference of solubility parameters of PVAc and isopropanol, (δₚ−δₛ)², is large, about 18.5 MPa (See Table 2 above), indicating a lack of affinity between PVAc and isopropanol. As shown in FIG. 22B, fibers with side-by-side morphology were produced under these conditions.

However, it was also found that a solvent with even lower evaporation rate than isopropanol, such as 1-butanol, leads to the formation of fibers having a core-shell morphology as shown in FIG. 22C. In this case, the value of Pₛ/Pₛ, was 0.27. In addition, 1-butanol has low affinity for PVAc as revealed from large value of (δₚ−δₛ)² of about 15.6 MPa. Thus, fibers with core-shell morphology were produced as a result of much faster evaporation of ethyl acetate from polymer solution in 1-butanol and ethyl acetate mixed solvents.

1. An apparatus for forming a non-woven mat of fibers using a stream of pressurized gas comprising:
a reservoir containing a spinnable fluid;
a nozzle in fluid communication with said reservoir;
a fluid pump for moving said spinnable fluid from said reservoir to said nozzle;
a solid surface having an opening therethrough wherein said nozzle is oriented to deliver said spinnable fluid through said nozzle and onto said solid surface and said solid surface is oriented so that said spinnable fluid flows along said solid surface when acted upon by the force of gravity; and
a means for producing a stream of pressurized gas at a predetermined gas pressure and flow rate across some or all of the surface of said spinnable fluid on said solid surface to produce a fiber.

2. The apparatus of claim 1 further comprising:
a first nozzle in fluid communication with a first fluid reservoir, said first fluid reservoir containing a first spinnable fluid; and
a second nozzle in fluid communication with a second fluid reservoir, said second fluid reservoir containing a second spinnable fluid;
wherein said first nozzle and said second nozzle are coaxial.

3. The apparatus of claim 1 further comprising:
a first nozzle in fluid communication with a first fluid reservoir, said first fluid reservoir containing a first spinnable fluid;
a second nozzle in fluid communication with a second fluid reservoir, said second fluid reservoir containing a second spinnable fluid
said solid surface having a first opening for receiving said first nozzle and a second opening for receiving said second nozzle;
wherein said first nozzle and said second nozzle are oriented in a vertical arrangement.

4. The apparatus of claim 1 wherein said fluid pump is a syringe pump and at least one reservoir is housed within said syringe pump.

5. The apparatus of claim 1 wherein the angle of said stream of pressurized gas relative to said solid surface is adjustable.

6. The apparatus of claim 1 wherein said flow rate is from about 0.05 cubic meters per second to about 0.5 cubic meters per.

7. The apparatus of claim 1 wherein said gas pressure is from about 5 psi to about 100 psi.

8. The apparatus of claim 1 wherein the feeding rate of said spinnable fluid, first spinnable fluid or second spinnable fluid through said nozzle is from about 0.1 mL per minute to about 10.0 mL per minute.

9. The apparatus of claim 1 further comprising a plurality nozzles for production of a plurality of fibers.

10. The apparatus of claim 9, wherein said plurality of nozzles are arranged in an array.

11. The apparatus of claim 1 further comprising a fiber collection area.

12. The apparatus of claim 11 wherein said fiber collection area is located from about 2 centimeters to about 500 centimeters from said solid surface.

13. The apparatus of claim 1 further comprising:
a first nozzle in fluid communication with a first fluid reservoir said first fluid reservoir being housed within a first syringe pump, wherein said first fluid reservoir contains a first spinnable fluid, the feeding rate of said first spinnable fluid through said first nozzle is from about 0.3 mL per minute to about 2.0 mL per minute, and said first spinnable fluid is a solution selected from the group consisting of polyethylene oxide dissolved in ethanol, polyvinyl pyrrolidone dissolved in ethanol, and polyvinyl acetate dissolved in ethyl acetate;
a second nozzle in fluid communication with a second fluid reservoir, said second fluid reservoir being housed within a second syringe pump, wherein said second fluid reservoir containing a second spinnable fluid, the feeding rate of said second spinnable fluid through said second nozzle is from about 0.3 mL per minute to about 2.0 mL per minute, and said second spinnable fluid is a solution selected from the group consisting of polyethylene oxide dissolved in ethanol, polyvinyl pyrrolidone dissolved in ethanol, and polyvinyl acetate dissolved in ethyl acetate; and
wherein said stream of pressurized gas comprises compressed air and said means for producing said stream of pressurized gas at a predetermined gas pressure and flow rate comprises a source of compressed air, a pressure regulator, a flow meter, and a rigid tube for directing the stream of pressurized gas; said flow rate is from about 0.10 cubic meters per second to about 0.20 cubic meters per second and said gas pressure is from about 10 psi to about 40 psi; and said fiber collection area is located from about 2 centimeters to about 200 centimeters from said solid surface.

14. An apparatus for forming a non-woven mat of fibers comprising:
a nozzle having a source end and an exit end,
a spinnable fluid, said spinnable fluid entering said nozzle at said source end, traveling the length of said nozzle, and forming a pendent drop at the exit end of said nozzle; and
a means for producing a stream of pressurized gas at a predetermined flow rate and pressure across said pendent drop of said spinnable fluid to produce fibers.

15. The apparatus of claim 14 wherein said means for producing a stream of pressurized gas at a predetermined gas pressure and flow rate comprises: an air compressor, a pressure regulator, a flow meter, and a rigid tube for directing the stream of pressurized gas.

16. The apparatus of claim 14 wherein said flow rate is from about 0.05 cubic meters per second to about 0.5 cubic meters per second.

17. The apparatus of any one of claim 14 wherein said gas pressure is from about 5 psi to about 100 psi and more preferably is from about 10 psi to about 40 psi.

18. The apparatus of one any of claim 14 further comprising a fiber collection area.

19. The apparatus of claim 18 wherein said fiber collection area is located from about 2 centimeters to about 500 centimeters from said nozzle.

20. The apparatus of any one of claim 65 wherein said nozzle is a capillary tube nozzle and the exit end of said capillary tube nozzle has an internal diameter of from about 0.5 millimeters to about 4.0 millimeters.

21. The apparatus of any one of claim 20 wherein said exit end of said capillary tube nozzle has an internal diameter of from about 1.0 millimeters to about 2.0 millimeters.

22. The apparatus of any one of claim 14, further comprising a plurality nozzles for production of a plurality of fibers.

23-28. (canceled)

29. The apparatus of claim 65 wherein said nozzle is a needle tip nozzle and the exit end of said needle tip nozzle has an internal diameter of from about 0.1 millimeters to about 3.0 millimeters.

30-64. (canceled)

65. The apparatus of claim 14 wherein said nozzle is a capillary tube nozzle or needle-tip nozzle.

66. The apparatus of any one of claim 29 wherein said nozzle is a needle tip nozzle and the exit end of said needle tip nozzle has an internal diameter of from about 0.3 millimeters to about 1.22 millimeters.

67. The apparatus of any one of claim 22, wherein said plurality of nozzles are arranged in an array.
